(19) United States
(12) Patent Application Publication
(10) Pub. No.: US 2026/0049242 A1
(43) Pub. Date: Feb. 19, 2026

(54) EMULSIFIED ACID SYSTEM FOR DRAG REDUCTION IN SUBTERRANEAN WELLS

(71) Applicant: King Fahd University of Petroleum and Minerals, Dhahran (SA)

(72) Inventors: Ala Shafeq AL-DOGAIL, Dhahran (SA); Rahul Narayanrao GAJBHIYE, Dhahran (SA); Theis Ivan SOLLING, Dhahran (SA); Abdullah Saad SULTAN, Dhahran (SA)

(73) Assignee: King Fahd University of Petroleum and Minerals, Dhahran (SA)

(21) Appl. No.: 19/282,884

(22) Filed: Jul. 28, 2025

Related U.S. Application Data
(60) Provisional application No. 63/683,031, filed on Aug. 14, 2024.

(51) Int. Cl. C09K 8/74; B82Y 30/00; B82Y 40/00; C09K 8/60; E21B 43/27

(52) U.S. Cl. CPC C09K 8/74; C09K 8/602; E21B 43/27; B82Y 30/00; B82Y 40/00; C09K 2208/10; C09K 2208/28

(57) ABSTRACT

A method of well injection with reduced drag includes injecting an emulsified acid system (EAS) into a subterranean geological formation including one or more hydrocarbons. The EAS includes an aqueous acid phase, a liquid organic phase, carbon nanodots, and an emulsifier. The carbon nanodots are present in an amount of 0.1 to 2 percent by volume (vol. %) based on a total volume of the EAS. The carbon nanodots are zero dimensional. The carbon nanodots include carbon in an amount of 75 to 85 percent by weight (wt. %) and oxygen in an amount of 15 to 25 wt. % based on a total weight of the carbon nanodots. The EAS has an aqueous mixture to liquid organic phase ratio of 60:40 to 80:20 by volume. The EAS is a water in oil emulsion.

### CROSS REFERENCE TO RELATED APPLICATION

This application claims the benefit of U.S. Provisional Application No. 63/683,031, filed Aug. 14, 2024, which is incorporated herein by reference in its entirety.

### STATEMENT REGARDING PRIOR DISCLOSURE BY THE INVENTORS

Aspects of the present disclosure are described in AL-Dogail, A. et al., “Novel Environmentally Friendly Nanomaterials for Drag Reduction of the Emulsified Acid System” published in Volume 8, Issue 46, ACS Omega (2023), which is incorporated herein by reference in its entirety.

### STATEMENT OF ACKNOWLEDGEMENT

Support provided by Haliburton-Saudi Arabia and King Fahd University of Petroleum and Minerals, Saudi Arabia, through Project DTV21101 is gratefully acknowledged.

### BACKGROUND

### Technical Field

The present disclosure is directed to a method of well injection, and more particularly towards a method of injecting an emulsified acid system with drag reduction in a subterranean geological formation.

### Description of Related Art

The “background” description provided herein is for the purpose of presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Well stimulation is a process used to enhance and increase productivity of oil and gas wells. It may be done by two different methods, matrix acidizing and hydraulic fracturing. Matrix acidizing is a process that uses acids to dissolve rock formations and create channels for oil and gas to flow through, and it is done at a pressure lower than the fracture pressure of the reservoir. Hydraulic fracturing is a process that uses high-pressure fluids to create cracks in the rock formation. These cracks allow oil and gas to flow more easily to the wellbore. Hydraulic fracturing is done at a pressure higher than the formation pressure.

Hydrochloric acid (HCl) acid systems are used in the petroleum industry to improve productivity of oil and gas wells by removing formation damage in carbonate reservoirs; however, there are challenges in delivering acid deep into reservoirs while minimizing rock face dissolution. Conventional acidizing fluids have limitations, such as strong acid strength, quick reaction with scale and fines, and corrosion of the tubing, casing, and downhole equipment at high temperatures. Acidizing is a technique used in the oil and gas industry to stimulate wells and enhance productivity of oil and gas wells. Conventional acidizing fluids that are used in the petroleum industry for well-stimulations of carbonate reservoirs contain HCl; however, fluids containing HClpossess high acid strength, leading to fast reactions with scales and fines near the wellbore. At high temperatures, acidizing fluids pose challenges for tubing, casing, gravel pack screens, and downhole pumps. Using HCl acid above 93° C. (200° F.) is not recommended due to its potential to damage the formation [Huang, T. et al. Stabilizing Emulsified Acids for Carbonate Acidizing, 2013]. Alternative acid systems have been developed to operate at high temperatures without causing damage to downhole equipment. Examples of such acid systems include a mixture of tricarboxylic acids, amino carboxylic acids, and dicarboxylic acids [Huang, T. et al. Stabilizing Emulsified Acids for Carbonate Acidizing]. By utilizing these acid systems, the oil and gas industry may overcome some limitations of the conventional acidizing fluids; however, these alternative acids are still limited to specific carbonate reservoir conditions. These acids have complex formulations, compatibility issues, and corrosion problems; however, the alternative acid systems are less corrosive compared to the conventional acidizing fluids. A need for another acidizing liquid is needed to overcome these limitations.

An emulsified acid system (EAS) is one solution to limitations of conventional acid systems. An EAS is typically made of acid and oil (usually diesel), with diesel acting as a diffusion barrier between the acid in the EAS and the rock [Fatah, W. A. and Nasr-El-Din, H. A., Acid Emulsified in Xylene: A Cost-Effective Treatment to Remove Asphaltene Deposition and Enhance Well Productivity SPE Production and Operations, 2009, 25, 2, 151-154]. An EAS is a type of water-in-oil (W/O) emulsion, in which the acid phase is encapsulated by the oil (diesel) phase using an emulsifier [Kasza, P., et al., From Laboratory Research to Successful Practice: A Case Study of Carbonate Formation Emulsified Acid Treatments, Proc. —SPE Int. Symp. Form. Damage Control, 2006; Nasr-El-Din, H. A. et al., Development and Field Application of a New, Highly Stable Emulsified Acid, SPE Annual Technical Conference and Exhibition, 2008; Sidaoui, Z. and Sultan, A. S. Formulating a Stable Emulsified Acid at High Temperatures: Stability and Rheology Study, International Petroleum Technology Conference, 2016; and AL-Dogail, A. et al., Development of Emulsified Acid System (EAS) Using Organoclays (OC): Rheology and Implication to the Acidizing: Geoenergy Sci. Eng., 2023]. EAS is a non-Newtonian shear-thinning fluid, meaning that its viscosity changes with the shear rate. An EAS may be represented by the power-law model, in which the viscosity reduces as the shear increases [Lynn, J. D. and Nasr-El-Din, H. A., A Core Based Comparison of the Reaction Characteristics of Emulsified and In-Situ Gelled Acids in Low Permeability, High Temperature, Gas Bearing Carbonates, Proceedings—SPE International Symposium on Oilfield Chemistry, 2001, 677-692; and Nasr-El-Din, H. A. et al., Stimulation of Water-Disposal Wells Using Acid-in-Diesel Emulsions: Case Histories, SPE Prod. Facil., 2000, 15, 3, 176-182]. An EAS is colloidal dispersions of two immiscible liquids, one of which is dispersed as droplets in the other [Adewunmi, A. A. et al. Emulsified Acid Systems for Oil Well Stimulation: A Review, J. Pet. Sci. Eng., 2022, 208, 109569; and Israelachvili, J., The Science and Applications of Emulsions—an Overview, Colloids Surfaces A Physicochem. Eng. Asp., 1994, 91, 1-8]. This dispersed phase is called the internal phase, while the continuous phase is the liquid that surrounds the droplets (external phase). Emulsions may be classified into four types: water-in-oil (W/O), oil-in-water (O/W), water-in-oil-in-water (W/O/W), and oil-in-water-in-oil (O/W/O). An emulsion is a combination of two immiscible fluids, where one fluid is referred to as the internal phase or dispersed phase, and the other is known as the external phase or continuous phase. In the case of an EAS, the continuous phase or external phase is diesel, which surrounds the HCl acid droplets, resulting in an acid-in-diesel emulsion and is a type of W/O emulsion. In the oil and gas industry, a concentrated HCl acid (typically ranging from 15-28%) is commonly used [Adewunmi, A. A. et al. Emulsified Acid Systems for Oil Well Stimulation: A Review, J. Pet. Sci. Eng., 2022, 208, 109569; and Al-Mutairi, S. H. et al. Effect of Droplet Size, Emulsifier Concentration, and Acid Volume Fraction on the Rheological Properties and Stability of Emulsified Acids, SPE Prod. Oper., 2007, 23, 4, 484-497]. EASs are used in fracturing and acidizing operations within carbonate reservoirs to improve formation permeability and increase oil and gas production. The presence of external (i.e., outer) phase of oil in the EAS leads to reduced or retarded reaction rates, resulting in the formation of deeper and narrower wormholes. This characteristic allows for more effective well stimulation and enhanced reservoir performance.

In the oil and gas industry, the most common type of emulsion is W/O. Emerging emulsion processing techniques, including microfluidic emulsification, may be used to regulate the number, size, and size distribution of droplets in an emulsion. Microfluidic emulsification is a technique that uses small channels to create emulsions with high droplet uniformity. This technique has the potential to improve the performance of emulsions in a variety of applications [Pal, R. Rheology of Simple and Multiple Emulsions, Curr. Opin. Colloid Interface Sci., 2011, 16, 1, 41-60].

Emulsions are unstable dispersions of two immiscible liquids. They may be categorized into three types based on their kinetic stability: loose emulsions (stable for a few minutes), medium emulsions (stable for ten minutes), and tight emulsions (stable for hours or days) [Tambe, D. E. and Sharma, M. M., Factors Controlling the Stability of Colloid-Stabilized Emulsions: I. An Experimental Investigation, Journal of Colloid and Interface Science, 1993, 157, 1, 244-253; and Abdulredha, M. M. et al., Overview on Petroleum Emulsions, Formation, Influence and Demulsification Treatment Techniques, Arab. J. Chem., 2020, 13, 1, 3403-3428]. The stability of an emulsion is affected by factors including the presence of heavy polar materials, small solids (organic and inorganic), temperature, droplet size distribution, brine pH, and brine composition [Kokal, S., Crude Oil Emulsions: Everything You Wanted to Know but Were Afraid to Ask, SPE Disting. Lect. Ser., 2008]. The pH of the brine has an impact on emulsion stability. Several emulsion upsets may occur after acid stimulation due to the precipitation of solids, primarily asphaltenes. This may lead to the formation of a tight and very stable emulsion, which may kill the well; therefore, design of an appropriate acid treatment to prevent emulsion upsets is needed.

An emulsifier is needed for forming an EAS by combining an aqueous acid phase with a diesel phase and enhancing its stability at high temperatures. To achieve this stability, very small particles, such as colloidal clay particles and/or nanoparticles, are incorporated into the EAS [Huang, T. et al. Stabilizing Emulsified Acids for Carbonate Acidizing, 2013]. The stabilized EAS includes at least one oil, an aqueous acid solution containing one or more acids, at least one emulsifier, and acid-insoluble nanoparticles with an average particle size of one thousand nanometers or smaller. Emulsified acids, where the acids are emulsified with oil (typically diesel), offer several advantages in oil and gas operations. They help minimize corrosion of pumping and downhole equipment and reduce the rate of reactions with carbonate reservoirs, particularly at high temperatures. This enables the active acid to penetrate deeply into the formation, enhancing well stimulation and overall reservoir performance. Preparation methods of emulsified acids impact their physical properties. Analyzing emulsified acids based on their droplet size distribution allows for a comprehensive understanding of their chemical composition and provides a description of their properties [Al-Mutairi, S. H. et al., Effect of Droplet Size, Emulsifier Concentration, and Acid Volume Fraction on the Rheological Properties and Stability of Emulsified Acids, SPE Prod. Oper., 2007, 23, 4, 484-497]. Achieving consistent and predictable results in emulsified acid treatments will ensure their effective application in various oilfield scenarios.

EAS may exist in either macroemulsion or microemulsion forms [Al-Anazi, H. A. et al., Stimulation of Tight Carbonate Reservoirs Using Acid-in-Diesel Emulsions: Field Application, SPE Formation Damage Control Conference, 1998, 1, 9-17; and Hoefner, M. L. et al., Role of Acid Diffusion in Matrix Acidizing of Carbonates, J. Pet. Technol., 1987, 39, 2, 203-208]. Macroemulsions, distinguished by their larger droplet size and need for less emulsifier, are the most commonly used in the field [Kasza, P. et al., From Laboratory Research to Successful Practice: A Case Study of Carbonate Formation Emulsified Acid Treatments, Proc. —SPE Int. Symp. Form. Damage Control, 2006, 571-577; Al-Anazi, H. A. et al., Stimulation of Tight Carbonate Reservoirs Using Acid-in-Diesel Emulsions: Field Application, SPE Formation Damage Control Conference, 1998, 1, 9-17; Mohamed, S. K. et al. Acid Stimulation of Power Water Injectors and Saltwater Disposal Wells in a Carbonate Reservoir in Saudi Arabia: Laboratory Testing and Field Results, Proceedings—SPE Annual Technical Conference and Exhibition, 1999, 247-262; Nasr-El-Din, H. A. et al., Stimulation of Water-Disposal Wells Using Acid-in-Diesel Emulsions: Case Histories, SPE Prod. Facil., 2000, 15, 3, 176-182; and Sayed, M. A. and Nasr-El-Din, H. A., Effect of Emulsifier Concentration and Acid Volume Fraction on the Elastic Properties of Emulsified Acids, SPE Middle East Oil Gas Show Conf MEOS, Proc., 2011, 2, 1173-1183]. An EAS formulation that combines three intensifiers for the stimulation of extremely high-temperature carbonate reservoirs was developed [Pandya, N. et al., Unique Emulsified Acid System with Three Intensifiers for Stimulation of Very High Temperature Carbonate Reservoirs, Society of Petroleum Engineers—Kuwait International Petroleum Conference and Exhibition KIPCE 2012: People and Innovative Technologies to Unleash Challenging Hydrocarbon Resources, 2012, 1, 373-379]. This EAS was designed for use in carbonate reservoirs with bottom-hole temperatures (BHT) of up to 163° C. (325° F.). The research provided insights into the impact of the intensifiers on the EAS perfortmance, contributing to a deeper understanding of the stimulation process. The findings offer good prospects for enhancing production in challenging high-temperature carbonate reservoirs.

A 26% HCl-based EAS was synthesized and investigated with two different corrosion inhibitors at various temperatures and time durations for stimulating high-temperature carbonate reservoirs [Sabhapondit, A. et al., Laboratory Optimization of an Emulsified Acid Blend for Stimulation of High-Temperature Carbonate Reservoirs, Society of Petroleum Engineers—North Africa Technical Conference and Exhibition, NATC 2012: Managing Hydrocarbon Resources in a Changing Environment, 2012, 1, 352-358]. Finding a balance between inhibitor and emulsifier concentrations help to design an effective and efficient EAS blend. A well-tailored EAS formulation may be capable of effectively stimulating high-temperature carbonate reservoirs while mitigating potential corrosion issues.

Matrix acidizing stimulation applied to a high-temperature carbonate reservoir, specifically the Sungai Kenawang (SKN) gas-condensate field located in the southwestern part of the Jambi Merang block in south Sumatra province, Indonesia, was studied via a stimulation process involving a combination of emulsified and viscoelastic self-diverting acids [Madyanova, M. et al., Effective Matrix Stimulation of High-Temperature Carbonate Formations in South Sumatra through the Combination of Emulsified and Viscoelastic Self-Diverting Acids, Proceedings—SPE International Symposium on Formation Damage Control, 2012, 1, 280-292]. Using highly retarded high-temperature EAS along with high-temperature viscoelastic surfactant led to stimulation throughout the targeted interval, resulting in a higher productivity index.

An experimental study aimed at enhancing well-stimulation through an improved EAS by exploring parameters such as pore pressure, flow rate, acid-rock contact time, and fluid treatment composition demonstrated efficacy of the stabilized system (i.e., the developed EAS), showcasing a threefold increase in core permeability improvement compared to conventional acid systems [Cairns, A. J. et al., Targeting Enhanced Production through Deep Carbonate Stimulation: Stabilized Acid Emulsions, SPE International Formation Damage Control Symposium Proceedings, 2016]. This outcome highlighted an improved EAS as a solution for achieving deeper and more effective well stimulation in various reservoir conditions.

A study examined the effects of water content, shear rate, shear stress, and temperatures on 30-day-aged W/O emulsions, considering different water cuts and the presence of an emulsifier [Umar, A. A. et al., Rheological and Stability Study of Water-in-Crude Oil Emulsions, AIP Conference Proceedings, 2016, 1774, 1, 040004]. The rheological properties of the W/O emulsions were analyzed at two different temperatures (25° C. and 60° C.) with varying water cuts. The results showed that the presence of emulsifier, water content, shear rate, and temperature exerted influence on the rheology and stability of the W/O emulsions. The study sheds light on the interplay of these factors and their impact on the behavior of W/O emulsions, providing insights for applications in the oil and gas industry.

Factors influencing the stability of HCl-EAS including the thermal stability and rheology of the EAS was experimentally investigated [Sidaoui, Z. and Sultan, A. S., Formulating a Stable Emulsified Acid at High Temperatures: Stability and Rheology Study, International Petroleum Technology Conference, 2016]. Varying the emulsifier concentration from 0.5 vol % to 1.5 vol % did not significantly affect the stability of the emulsified acid. The small droplet size of the emulsion contributed to its higher viscosity, and as the temperature increased, the apparent viscosity of the EAS decreased.

Utilization of waste oil as the external phase of a 70:30 acid/oil ratio with 15% HCl in an EAS revealed the potential of waste oil as a viable external phase for preparing EAS targeted for high-temperature carbonate reservoirs [Sidaoui, Z. et al., Viscoelastic Properties of Novel Emulsified Acid Using Waste Oil: Effect of Emulsifier Concentration, Mixing Speed and Temperature, Society of Petroleum Engineers—SPE Kingdom of Saudi Arabia Annual Technical Symposium and Exhibition, 2016; and Sidaoui, Z. et al., Novel Approach to Formulation of Emulsified Acid Using Waste Oil, Society of Petroleum Engineers—SPE Kingdom of Saudi Arabia Annual Technical Symposium and Exhibition, 2017, 1657-1680]. The HCl-waste oil EAS demonstrated shear-thinning behavior, exhibiting favorable rheological properties. Adding iron control and chelating agents to EAS was investigated for its stability and reaction with dolomite, and the findings indicate that the most stable EAS was achieved without iron control and with the inclusion of an initial concentration of the chelating agents [Sidaoui, Z. et al., Achieving Higher Retardation of Emulsified Acid by Additive Optimization, Society of Petroleum Engineers—SPE Kingdom of Saudi Arabia Annual Technical Symposium and Exhibition, 2018].

A novel low-viscosity retarded acid system designed for stimulating high-temperature carbonate reservoirs effectively reduced the presence of free water within the system, thereby preventing complete dissociation of the acid [Sayed, M. et al., A Low-Viscosity Retarded Acid System for Stimulation of High-Temperature Deep Wells, Proc. Annu. Offshore Technol. Conf., 2018, 6, 3985-4004]. The acid system required a pore volume (PV) of 0.28 or more to achieve a breakthrough in a 12-inch core sample. This low PV requirement sets the acid system apart from other EASs and offers advantages in terms of fluid viscosity. The fluid viscosity of the acid system was lower compared to conventional EAS, resulting in reduced drag during pumping and enabling higher pumping rates.

An innovative low-viscosity retarded acid system involved the combination of a potent acid with a highly soluble organic compound [Aldakkan, B. et al., Low Viscosity Retarded Acid System: A Novel Alternative to Emulsified Acids”, SPE Kingdom of Saudi Arabia Annual Technical Symposium and Exhibition, 2018, 1-23]. The acid system achieved a four-fold reduction in core weight loss due to the dissolution compared to the conventional 15-weight percent HCl acid. Additionally, the acid system exhibited minimal corrosion effects and a delayed acid reaction with calcite.

A cost-effective and highly stable EAS for stimulating deep wells in carbonate reservoirs utilized specific nanoparticles as an alternative instead of conventional surfactants [Ahmed, M. et al, A Novel Emulsified Acid for Deep Wells Stimulation: Rheology, Stability, and Coreflood Study, Society of Petroleum Engineers—SPE Kingdom of Saudi Arabia Annual Technical Symposium and Exhibition, 2018]. Core flooding experiments were conducted to evaluate the efficacy of the developed EAS in stimulating deep limestone reservoirs, comparing the results with a conventional EAS formed using diesel. The diesel EAS performed better at low injection rates, and the developed EAS with waste oil showed superior results in the stimulation process. The EAS stability is influenced by various parameters, including emulsifier concentration, acid-to-oil ratio, types of acid and oil used, chemical additives, and the chosen preparation method.

An eco-friendly approach to preparing an EAS for matrix acidizing of carbonate rocks by substituting diesel with an environmentally friendly oil, oil from Jatropha curcas oil. The study demonstrated that the Jatropha oil-based EAS may effectively replace diesel in the EAS formulation for matrix acidizing [Yousufi, M. M. et al., Synthesis and Evaluation of Jatropha Oil-Based Emulsified Acids for Matrix Acidizing of Carbonate Rocks, J. Pet. Explor. Prod. Technol., 2019, 9, 2, 1119-1133]. The Jatropha oil-based EAS exhibited enhanced thermal stability compared to the conventional diesel-based EAS. The Jatropha oil-based EAS exhibited low toxicity and contained a high content of fatty acids. These characteristics enhance its potential as a safer and more environmentally conscious alternative for acidizing operations in the oil and gas industry.

A stable EAS suitable for high-pressure-high-temperature (HPHT) wells, operating at 149° C., utilized a non-aromatic non-ionic surfactant to develop the EAS [Sokhanvarian, K. et al., Novel Non-Aromatic Non-Ionic Surfactants to Target Deep Carbonate Stimulation, Proceedings—SPE International Symposium on Oilfield Chemistry, 2019]. The non-ionic surfactant effectively enabled the preparation of a stable EAS, which exhibited enhanced performance in well stimulation with low acid pore volume breakthrough (PVBT) at 149° C.

A multi-batched acid system designed to enhance the stimulation efficiency of heterogeneous carbonate reservoirs was effective in stimulating such complex carbonate reservoirs, leading to improved reservoir performance [Jafarpour, H. et al., Increasing the Stimulation Efficiency of Heterogeneous Carbonate Reservoirs by Developing a Multi-Bached Acid System, J. Pet. Sci. Eng., 2019, 172, 50-59].

A low-viscosity single-phase acid system tailored for acid fracturing in deep carbonate reservoirs operating at high temperatures consisted of a pre-engineered blend of an alkyl sulfonic acid and strong mineral acid [Sayed, M. et al., Low-Viscosity Single Phase Acid System for Acid Fracturing in Deep Carbonate Reservoirs, MRS Commun., 2021, 11, 6, 796-803]. The acid system exhibited comparable performance to 15 wt % HCl-EAS in terms of diffusion coefficient. Additionally, the low viscosity of the acid system resulted in reduced drag, facilitating high pumping rates through the tubular, and contributing to efficient well stimulation in deep carbonate reservoirs.

A low-viscosity, polymer-free acid retarded system involving a combination of a robust mineral acid, such as HCl, with a non-damaging retarding agent was used in a west Kuwait field [Al-Sabea, S. H. et al., Low Viscosity Polymer Free Acid Retarded System, a Novel Alternative to Emulsified Acid: Successful Application in West Kuwait Field, International Petroleum Technology Conference, 2022]. The acid system exhibited promise compared to EASs pumped in a nearby well. Furthermore, the acid system offered additional benefits by reducing environmental concerns and minimizing costs. This approach presents an attractive solution for effective well stimulation in the west Kuwait field, promoting greater reservoir productivity and hydrocarbon recovery. The environmentally friendly and cost-efficient nature of the proposed acid system further strengthens its viability for application in various oil and gas operations via deeper penetration of HCl into formations.

An innovative and polymer-free delayed HCl acid system with low viscosity was designed for stimulating high-temperature carbonate reservoirs [Zakaria, A. et al., Novel Low Viscosity, Single Phase, Polymer-Free Delayed HCl Acid System for Stimulation of High Temperature Carbonate Reservoirs, SPE International Conference and Exhibition on Formation Damage Control, 2022]. The delayed HCl acid system showed a reduced acid PVBT compared to standard HCl acid systems at all injection rates. Moreover, the utilization of this low-viscosity delayed HCl acid system enhanced acid penetration, allowing for access to deeper reservoir areas and contributing to the success of the acid stimulation process.

Different types of organoclays (OC) as emulsifiers were used to develop Pickering EAS [AL-Dogail, A. et al., Development of Emulsified Acid System (EAS) Using Organoclays (OC): Rheology and Implication to the Acidizing, Geoenergy Sci. Eng., 2023]. Some types of OCs may be used as emulsifiers to develop pickering EAS with good thermal stability and low viscosity at high shear rates.

US20120181033A1 discloses nanohybrid phase interfaces for foaming in oil field applications. It focuses on nanohybrid materials, which include components such as silica and carbon nanotubes. US20180282615A1 discusses controlling the rheology of the treating fluid by varying the size ratio between solid particles and the dispersed fluid.

Several studies have explored the formulation of EAS to overcome the limitation of conventional acid fluid for stimulation. EAS involves acids dispersed in an external oil phase, offering benefits like reduced corrosion and controlled reaction rates. EAS formulations for well stimulation are required to be stable at high-temperature carbonate reservoirs. Emulsion stability varies based on factors like pH, temperature, and droplet size distribution and needs to be addressed while developing the EAS.

EAS has been used to stimulate carbonate reservoirs; however, limitations such as low stability at elevated temperatures, high viscosity that restricts pumping rates, the potential for formation damage, and the difficulty of achieving homogeneous field-scale mixing limit its application. The currently used EASs prevent injection or pumping at low flow rates and limits the placement (depth of penetration) in the matrix or fractured systems. Addressing this problem is still challenging, and the emulsified acid treatment design has aimed at placing the acid as fast and deep as friction allows. Reducing the drag in pipes may allow for higher pumping rates and enhance the efficiency of the EAS treatment, as well as saving energy.

Various EAS formulations have been explored for well stimulation in high-temperature carbonate reservoirs. These include macro and microemulsions, low-viscosity systems, and formulations with alternative components like nanoparticles or waste oil. Factors influencing EAS stability and performance include emulsifier concentration, acid-to-oil ratio, and temperature. Diverse solutions to have been used in EASs for deeper penetration, reduced core loss, and more efficient stimulation, especially in challenging reservoir conditions. Such innovations may enhance oil and gas production while addressing environmental and operational concerns.

Limited studies on the drag reduction of EASs have addressed the drag reduction of emulsion but not the emulsified acid system. Achieving drag reduction of emulsion cannot be translated to drag reduction of the EAS. The nature of EAS should be considered while addressing the drag reduction of the EAS, which includes compatibility of the material with acid and ensuring the formation of an emulsion that is thermally stable and possesses characteristics of an emulsion that is ready to use considering operating and field conditions.

Each EAS suffers from one or more drawbacks hindering their adoption. Accordingly, an object of the present disclosure is to provide methods and systems for an emulsified acid system for drag reduction that may circumvent drawbacks, such as low stability at elevated temperatures, high viscosity that restricts pumping rates, the potential for formation damage, difficulty of achieving homogeneous field-scale mixing, and high cost factor, known in the art.

### SUMMARY

In an exemplary embodiment, a method of well injection with reduced drag is described. The method includes injecting an emulsified acid system into a subterranean geological formation including one or more hydrocarbons. The emulsified acid system includes an aqueous acid phase, a liquid organic phase, carbon nanodots, and an emulsifier. The carbon nanodots are present in an amount of 0.1 to 2 percent by volume (vol. %) based on a total volume of the emulsified acid system, and the carbon nanodots are zero dimensional.

The carbon nanodots include carbon in an amount of 75 to 85 percent by weight (wt. %) and oxygen in an amount of 15 to 25 wt. % based on a total weight of the carbon nanodots. The emulsified acid system has an aqueous mixture to liquid organic phase ratio of 60:40 to 80:20 by volume, and the emulsified acid system is a water in oil emulsion.

In some embodiments, the aqueous acid phase includes hydrochloric acid and the emulsified acid system does not contain silica.

In some embodiments, a concentration of the acid is 10 to 25 grams per 100 grams of the emulsified acid system and the emulsified acid system does not contain silica and the only particles in the emulsified acid system are the carbon nanodots.

In some embodiments, the liquid organic phase includes diesel.

In some embodiments, the emulsified acid system further includes a corrosion inhibitor, an inhibitor intensifier, and one or more iron controls.

In some embodiments, the emulsified acid system has an aqueous mixture to liquid organic phase ratio of 65:35 to 75:25 by volume.

In some embodiments, the liquid organic phase in the emulsified acid system is an external phase.

In some embodiments, injecting occurs at an emulsified acid system temperature of 20 to 130 degree Celsius (° C.).

In some embodiments, the emulsified acid system includes carbon nanodots in an amount of 0.3 to 0.5 vol. % based on a total volume of the emulsified acid system.

In some embodiments, the carbon nanodots have a diameter of 2 to 4 nanometers (nm).

In some embodiments, the emulsifier is a nonionic surfactant sorbitan ester.

In some embodiments, a method of making the emulsified acid system includes mixing the liquid organic phase and the emulsifier to form a first solution. Further, the method includes mixing the aqueous acid phase, a corrosion inhibitor, an inhibitor intensifier, and one or more iron controls to form a second solution. The method further includes adding the second solution to the first solution to form a third solution. Furthermore, the method includes mixing the carbon nanodots with the third solution to form the emulsified acid system.

In some embodiments, the carbon nanodots include carbon in an amount of 78 to 82 wt. % and oxygen in an amount of 18 to 22 wt. % based on a total weight of the carbon nanodots.

In some embodiments, the emulsified acid system has a viscosity of 20 to 30 centipoise (cP) at a shear rate of 10 per second (sec⁻¹) at 65° C.

In some embodiments, the emulsified acid system has a pressure drop of 48,000 to 52,000 pascals per meter (Pa/m) at a flow rate of 10 to 11 liters per minute (L/min) at 25° C.

In some embodiments, the emulsified acid system loses less than 10 vol. % of the one or more hydrocarbons out of the emulsified acid system at a temperature of 80° C. after 24 hours.

In some embodiments, the emulsified acid system has a shear stress of 0.2 to 0.4 Pascals (Pa) at a shear rate of 10 inverse seconds (sec⁻¹) at 65° C.

In some embodiments, the emulsified acid system has a drag reduction of 7000 to 9000 Pa at a flow rate of 10 L/min and a temperature of 25° C. compared to an emulsified acid system without carbon nanodots.

In some embodiments, the emulsified acid system has a drag reduction of 11,000 to 13,000 Pa at a flow rate of 12 L/min and a temperature of 25° C. compared to an emulsified acid system without carbon nanodots.

In some embodiments, a method of making the carbon nanodots includes mixing citric acid and ethanolamine to form a solution and heating the solution to a temperature of 400 to 500° C. for 20 to 40 minutes to form a product. The method further includes mixing the product in water to form a dispersion and dialyzing the dispersion against water to form the carbon nanodots.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof may be readily obtained as the same becomes better understood by reference to the following detailed description when considered in connection with the accompanying drawings, wherein:

FIG. 1A is a schematic flowchart of a method of preparing an emulsified acid system, according to certain embodiments.

FIG. 1B is a schematic flowchart of a method of preparing carbon nanodots, according to certain embodiments.

FIG. 2 is an exemplary illustration of an emulsified acid system (EAS) preparation, according to certain embodiments.

FIG. 3A depicts electrical conductivity and drop-test of the EAS (base case as an example), according to certain embodiments.

FIG. 3B depicts drop-test of EAS in water and diesel, according to certain embodiments.

FIG. 4A depicts separation volume of the EAS at 25° C. (EAS+0.4% nanomaterial (NM) as an example), according to certain embodiments.

FIG. 4B depicts separation volume of the EAS at 80° C. (EAS+0.4% NM as an example), according to certain embodiments.

FIG. 4C depicts separation volume of the EAS at 120° C. (EAS+0.4% NM as an example), according to certain embodiments.

FIG. 5A depicts the EAS at 25° C. before (left) and after (right) oven (EAS+0.4% NM as an example), according to certain embodiments.

FIG. 5B depicts photo of the EAS at 80° C. before (left) and after (right) oven (EAS+0.4% NM as an example), according to certain embodiments.

FIG. 5C depicts photo of the EAS at 120° C. before (left) and after (right) oven (EAS+0.4% NM as an example), according to certain embodiments.

FIG. 6 depicts 15% hydrochloric acid (HCl) EAS viscosity (cP) vs. shear rate (1/sec) at 65° C., according to certain embodiments.

FIG. 7 depicts 15% HCl EAS shear stress (Pa) vs. shear rate (1/sec) at 65° C., according to certain embodiments.

FIG. 8 depicts 15% HCl EAS viscosity (cP) vs. shear rate (1/sec) at 65° C. (repeated 3 times), according to certain embodiments.

FIG. 9 depicts 15% HCl EAS shear stress (Pa) vs. shear rate (1/sec) at 65° C. (repeated 3 times), according to certain embodiments.

FIG. 10 depicts 20% HCl EAS viscosity (cP) vs. shear rate (1/sec) at 65° C., according to certain embodiments.

FIG. 11 depicts 20% HCl EAS shear stress (Pa) vs. shear rate (1/sec) at 65° C., according to certain embodiments.

FIG. 12 depicts 15% HCl EAS viscosity (cP) vs. shear rate (1/sec) at 65° C. (tested with another corrosion inhibitor), according to certain embodiments.

FIG. 13 depicts 15% HCl EAS shear stress (Pa) vs. shear rate (1/sec) at 65° C. (tested with another corrosion inhibitor), according to certain embodiments.

FIG. 14 depicts 15% HCl EAS viscosity (cP) vs. shear rate (1/sec) at 65° C. (sample after flow experiment), according to certain embodiments.

FIG. 15 depicts 15% HCl EAS shear stress (Pa) vs. shear rate (1/sec) at 65° C. (sample after flow experiment), according to certain embodiments.

FIG. 16 depicts 15% HCl EAS viscosity (cP) vs. shear rate (1/sec) at 65° C. (new batch), according to certain embodiments.

FIG. 17 depicts 15% HCl EAS shear stress (Pa) vs. shear rate (1/sec) at 65° C. (new batch), according to certain embodiments.

FIG. 18 is an exemplary illustration of a drag reduction flow loop system, according to certain embodiments.

FIG. 19 depicts a drag reduction flow loop calibration curve with diesel, according to certain embodiments.

FIG. 20 is an exemplary illustration of EAS preparation for flow experiment, according to certain embodiments.

FIG. 21 is an exemplary illustration of EAS flow experiment, according to certain embodiments.

FIG. 22 is a graph depicting a flow experiment of 15% HCl-EAS (base case) at 25° C., according to certain embodiments.

FIG. 23 is a graph depicting effect of temperatures on the 15% HCl-EAS (base case) flow experiment, according to certain embodiments.

FIG. 24A depicts effects of adding NM to the 15% HCl-EAS (base case) on pressure drop at 25° C. at forward flow rates, according to certain embodiments.

FIG. 24B depicts effects of adding NM to the 15% HCl-EAS (base case) on pressure drop at 25° C. at backward flow rates, according to certain embodiments.

FIG. 25A depicts effects of adding NM to the 15% HCl-EAS (base case) on shear stress at 25° C. at forward flow rates, according to certain embodiments.

FIG. 25B depicts effects of adding NM to the 15% HCl-EAS (base case) on shear stress at 25° C. at backward flow rates, according to certain embodiments.

FIG. 26A depicts effects of adding NM to the 15% HCl-EAS (base case) on pressure drop at 40° C. at forward flow rates, according to certain embodiments.

FIG. 26B depicts effects of adding NM to the 15% HCl-EAS (base case) on pressure drop at 40° C. at backward flow rates, according to certain embodiments.

FIG. 27A depicts effects of adding NM to the 15% HCl-EAS (base case) on pressure drop at 50° C. at forward flow rates, according to certain embodiments.

FIG. 27B depicts effects of adding NM to the 15% HCl-EAS (base case) on pressure drop at 50° C. at backward flow rates, according to certain embodiments.

FIG. 28 depicts effect of temperatures on the 20% HCl-EAS flow experiment, according to certain embodiments.

FIG. 29 depicts effects of adding NM to the 20% HCl-EAS on pressure drop at 25° C., according to certain embodiments.

FIG. 30 depicts effects of adding NM to the 20% HCl-EAS on pressure drop at 40° C., according to certain embodiments.

FIG. 31 depicts effects of adding NM to the 20% HCl-EAS on pressure drop at 50° C., according to certain embodiments.

FIG. 32 depicts 20% HCl EAS viscosity (cP) vs. shear rate (1/sec) at 65° C., according to certain embodiments.

FIG. 33 depicts 20% HCl EAS stability for 24 hours at 65° C., according to certain embodiments.

FIG. 34 depicts X-ray photoelectron spectra (XPS) of the carbon nanodots, according to certain embodiments.

### DETAILED DESCRIPTION

When describing the present disclosure, the terms used are to be construed in accordance with the following definitions, unless a context dictates otherwise.

Embodiments of the present disclosure will now be described more fully hereinafter with reference to the accompanying drawings wherever applicable, in that some, but not all, embodiments of the disclosure are shown.

In the drawings, like numbered reference numerals will be used to designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “room temperature” refers to a temperature range of '25±3 degrees Celsius (° C.).

As used herein, the term “well injection” refers to a process by which fluids, such as emulsified acids, are introduced into a wellbore of a subterranean formation to treat or stimulate a subterranean formation, improve hydrocarbon recovery, and/or manage formation damage.

As used herein, the term “reduced drag” refers to a decrease in frictional resistance encountered by a fluid flowing through a conduit or porous medium, which enhances flow efficiency and lowers the pumping pressure.

As used herein, the term “emulsified acid system” refers to a fluid composition in which an aqueous acid phase is dispersed within a continuous oil phase using surfactants and/or emulsifiers to form a stable emulsion, typically for controlled acid delivery in well stimulation.

As used herein, the term “external phase” (also referred to as a “continuous phase”) refers to a liquid that surrounds and suspends droplets in an emulsion.

As used herein, the term “dispersed phase” refers to a liquid that is broken up into droplets and is suspended in a second liquid (i.e., the external phase)

As used herein, the term “subterranean geological formation” refers to a naturally occurring layer or structure of rock or sediment located beneath the Earth's surface, often targeted for extraction of hydrocarbons, gas, and/or water.

As used herein, the term “water in oil emulsion” refers to a type of emulsion in which water-based droplets, such as an aqueous acid solution, are dispersed throughout a continuous oil phase, providing controlled release and stability in downhole environments.

As used herein, the term “shear rate” refers to a measure of the rate at which adjacent layers of fluid move with respect to each other, typically expressed in inverse seconds (s⁻¹), and is indicative of flow behavior under applied force.

As used herein, the term “viscosity” refers to a fluid's resistance to flow, reflecting its internal friction and typically expressed in centipoise (cP). A higher viscosity indicates thicker fluids that flow more slowly.

As used herein, the term “shear stress” refers to a measure of the force per unit area exerted parallel to the direction of fluid flow, which is used to characterize the response of a fluid under deformation or flow.

As used herein, the term “pressure drop” refers to a decrease in pressure as a fluid moves through a system or conduit, often caused by friction, changes in elevation, and/or restrictions in the flow path.

As used herein, the term “corrosion inhibitor” refers to a chemical additive that slows or prevents corrosive degradation of metal surfaces, particularly in acidic environments such as those encountered during acidizing operations.

As used herein, the term “an inhibitor intensifier” refers to a chemical agent that enhances performance of a corrosion inhibitor, especially under high-temperature or high-pressure conditions, to promote continued protection of metallic surfaces.

As used herein, the term “flow rate” refers to a measure of volume or mass of fluid passing through a given point or area per unit time, typically expressed in liters per minute (L/min) or gallons per minute (GPM).

A weight percent of a component, unless specifically stated to the contrary, is based on the total weight of the formulation or composition in which the component is included. For example, if a particular element or component in a composition or article is said to have 5 percent by weight (wt. %), it is understood that this percentage is in relation to a total compositional percentage of 100%.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers.

An aspect of the present disclosure is directed to the use of carbon nanodots (CNDs) as drag-reducing agents in emulsified acid systems (EAS) to lower viscosity, reduce drag, and enhance energy efficiency during matrix acidizing operations.

A method of well injection with reduced drag is described. The well injection includes injecting an emulsified acid system into a subterranean geological formation including one or more hydrocarbons. In some embodiments, the injecting occurs at an emulsified acid system temperature of 20 to 130° C., preferably 25 to 125° C., preferably 30 to 120° C., preferably 35 to 115° C., preferably 40 to 110° C., preferably 45 to 105° C., preferably 50 to 100° C., preferably 55 to 95° C., preferably 60 to 90° C., preferably 65 to 85° C., and preferably 70 to 80° C. In a preferred embodiment, the injecting occurs at an emulsified acid system temperature of about 25° C. In another preferred embodiment, the injecting occurs at an emulsified acid system temperature of about 80° C. In yet another preferred embodiment, the injecting occurs at an emulsified acid system temperature of about 120° C.

The emulsified acid system includes an aqueous acid phase, a liquid organic phase, carbon nanodots, and an emulsifier. The carbon nanodots are present in an amount of 0.1 to 2 percent by volume (vol. %), preferably 0.2 to 1.9 vol. %, preferably 0.3 to 1.8 vol. %, preferably 0.4 to 1.7 vol. %, preferably 0.5 to 1.6 vol. %, preferably 0.6 to 1.5 vol. %, preferably 0.7 to 1.4 vol. %, preferably 0.8 to 1.3 vol. %, preferably 0.9 to 1.2 vol. %, and preferably 1 to 1.1 vol. % based on a total volume of the emulsified acid system. The carbon nanodots are zero dimensional. As used herein, the term “zero-dimensional (OD)” in reference to the carbon nanodots refers to discrete, isotropic carbon nanoparticles that are quantum-confined in all three spatial dimensions. Zero-dimensional carbon nanodots typically refer to having all dimensions confined to a nanoscale (typically <10 nm) and having no extended length in any direction. In some embodiments, the CNDs used as a drag reducing agent may be 3-8 nm, preferably 4-7 nm, and preferably 5-6 nm. In the CNDs, every principal axis of the nanodot is less than about 10 nm, typically 2-8 nm, with an aspect ratio not exceeding 2:1. Because no dimension extends beyond the nanoscale, the nanodots do not form one-dimensional (i.e., nanotube-like) or two-dimensional (i.e., graphene-like) structures but instead behave as point-like entities with size-dependent optical and electronic properties. The carbon nanodots include carbon in an amount of 75 to 85 percent by weight (wt. %), preferably 76 to 84 wt. %, preferably 77 to 83 wt. %, preferably 78 to 82 wt. %, and preferably 79 to 81 wt. % based on a total weight of the carbon nanodots. The emulsified acid system has an aqueous mixture to liquid organic phase ratio of 60:40 to 80:20, preferably 62:38 to 78:22, preferably 64:36 to 76:34, preferably 66:34 to 74:26, preferably 68:32 to 72:28 by volume. In some embodiments, the aqueous mixture includes the aqueous acid phase, the carbon nanodots, and the emulsifier. In some embodiments, the emulsified acid system further includes a corrosion inhibitor, an inhibitor intensifier, and one or more iron controls. In some embodiments, the aqueous mixture includes the aqueous acid phase, the carbon nanodots, the emulsifier, the corrosion inhibitor, the inhibitor intensifier, and the one or more iron controls. In an embodiment, the liquid organic phase in the emulsified acid system is an external phase.

The emulsified acid system is a water in oil emulsion. The aqueous acid phase is dispersed as fine droplets within a continuous oil phase. This structure allows controlled release of acid, improved penetration into target zones, and reduced corrosion to metal surfaces due to limited direct acid contact. The stability of the emulsion may be maintained by suitable surfactants that reduce interfacial tension and prevent phase separation.

In some embodiments, the emulsified acid system has a viscosity of 20 to 30 cP, preferably 21 to 29 cP, preferably 22 to 28 cP, preferably 23 to 27 cP, and preferably 24 to 26 cP at a shear rate of 10 sec⁻¹ at 65° C. In some embodiments, the emulsified acid system has a shear stress ranging from 0.2 to 0.4 Pa, preferably 0.21 to 0.39 Pa, preferably 0.22 to 0.38 Pa, preferably 0.23 to 0.37 Pa, preferably 0.24 to 0.36 Pa, preferably 0.25 to 0.35 Pa, preferably 0.26 to 0.34 Pa, preferably 0.27 to 0.33 Pa, preferably 0.28 to 0.23 Pa, and preferably 0.29 to 0.21 Pa at a shear rate of 10 sec⁻¹ at 65° C.

In some embodiments, the emulsified acid system has a pressure drop of 48,000 to 52,000 Pa/m, preferably 48,500 to 51,500 Pa/m, preferably 49,000 to 51,000 Pa/m, preferably 49,500 to 50,500 Pa/m at a flow rate of 10 to 11 L/min, preferably 10.2 to 10.8 L/min, and preferably 10.4 to 10.6 L/min at 25° C. In a preferred embodiment, the emulsified acid system has a pressure drop of about 50,000 Pa/m at a flow rate of about 10 L/min at 25° C.

In some embodiments, the emulsified acid system has a pressure drop ranging from 30,000 to 52,000 Pa/m, preferably 32,000 to 50,000 Pa/m, preferably 34,000 to 48,000 Pa/m, preferably 36,000 to 46,000 Pa/m, preferably 38,000 to 44,000 Pa/m, and preferably 40,000 to 42,000 Pa/m at a flow rate of 10 to 11 L/min, preferably 10.2 to 10.8 L/min, and preferably 10.4 to 10.6 L/min at 40° C. In a preferred embodiment, the emulsified acid system has a pressure drop of about 38,000 Pa/m at a flow rate of about 10 L/min at 40° C.

In some embodiments, the emulsified acid system has a pressure drop ranging from 30,000 to 52,000 Pa/m, preferably 32,000 to 50,000 Pa/m, preferably 34,000 to 48,000 Pa/m, preferably 36,000 to 46,000 Pa/m, preferably 38,000 to 44,000 Pa/m, and preferably 40,000 to 42,000 Pa/m at a flow rate of 10 to 11 L/min, preferably 10.2 to 10.8 L/min, and preferably 10.4 to 10.6 L/min at 50° C. In a preferred embodiment, the emulsified acid system has a pressure drop of about 35,000 Pa/m at a flow rate of about 10 L/min at 50° C.

In some embodiments, the emulsified acid system loses less than 10 vol. %, preferably less than 9 vol. %, preferably less than 8 vol. %, preferably less than 7 vol. %, preferably less than 6 vol. %, preferably less than 5 vol. %, preferably less than 4 vol. %, preferably less than 3 vol. %, preferably less than 2 vol. %, and preferably less than 1 vol. % of the one or more hydrocarbons out of the emulsified acid system at a temperature of 80° C. after 24 hours.

In some embodiments, the emulsified acid system has a drag reduction ranging from 7000 to 9000 Pa, preferably 7200 to 8800 Pa, preferably 7400 to 8600 Pa, preferably 7600 to 8400 Pa, and preferably 7800 to 8200 Pa at a flow rate of 10 L/min and a temperature of 25° C. compared to an emulsified acid system without carbon nanodots. In a preferred embodiment, the emulsified acid system has a drag reduction of about 8000 Pa at a flow rate of 10 L/min and a temperature of 25° C. compared to an emulsified acid system without carbon nanodots.

In some embodiments, the emulsified acid system has a drag reduction ranging from 11,000 to 13,000 Pa, preferably 11,200 to 12,800 Pa, preferably 11,400 to 12,600 Pa, preferably 11,600 to 12,400 Pa, and preferably 11,800 to 12,200 Pa at a flow rate of 12 L/min and a temperature of 25° C. compared to an emulsified acid system without carbon nanodots. In a preferred embodiment, the emulsified acid system has a drag reduction of about 12,000 Pa at a flow rate of 12 L/min and a temperature of 25° C. compared to an emulsified acid system without carbon nanodots.

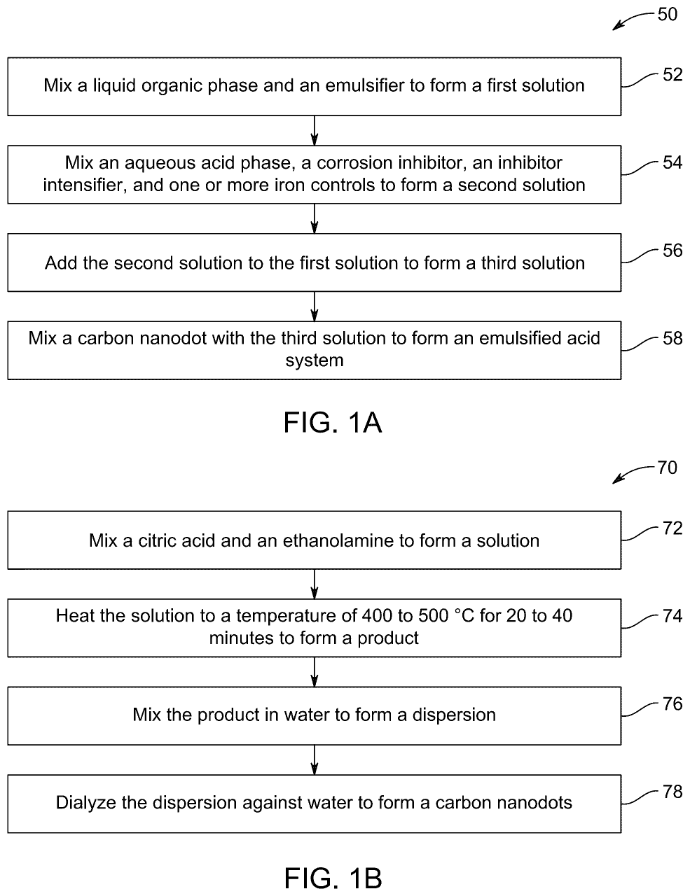

FIG. 1A illustrates a schematic flow chart of a method 50 of preparing the emulsified acid system. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing the liquid organic phase and the emulsifier to form a first solution. In some embodiments, the mixing may be done manually, by a stirrer, a magnetic stir bar and plate, a sonicator, a high-speed mixer, a high-shear mixer, an overhead stirrer, a homogenizer, an ultrasonic processor, a propeller agitator, a paddle mixer, a turbine mixer, a planetary mixer, a vortex mixer, an emulsification pump, a rotor-stator mixer, a static mixer, a ribbon blender, a ball mill mixer, an anchor stirrer, an inline mixer, a high-pressure homogenizer, a screw agitator, a centrifugal mixer, a peristaltic mixer, an impeller mixer, a sigma blade mixer, a double planetary mixer, a conical screw mixer, a twin-screw mixer, a kneader reactor, a disperser, a gear-driven stirrer, an orbital shaker, a combination thereof, and any mixing method and equipment known in the art. In a preferred embodiment, the liquid organic phase and the emulsifier are mixed with the homogenizer.

In some embodiments, the liquid organic phase may include, but is not limited to, kerosene, toluene, xylene, naphtha, mineral oil, hexane, heptane, octane, cyclohexane, light crude oil, refined oil, benzene, decane, isooctane, jet fuel, turpentine, fuel oil, synthetic oil, base oil, diesel, white spirit, paraffin oil, dodecane, tetradecane, squalane, isohexadecane, isoparaffinic solvents, methylcyclohexane, nonane, solvent 140, petroleum ether, a combination thereof, and the like. In a preferred embodiment, the liquid organic phase comprises diesel.

In some embodiments, the emulsifier may include, but is not limited to, sorbitan monooleate (Span 80), polyoxyethylene sorbitan monooleate (Tween 80), sorbitan monostearate (Span 60), laureth-4, ethoxylated nonylphenol, polyglycerol esters, lecithin, PEG-40 hydrogenated castor oil, sodium lauryl sulfate, poloxamer 188, cetyltrimethylammonium bromide, polysorbate 20, polyoxyethylene (20) sorbitan monolaurate, stearyl alcohol ethoxylate, alkyl polyglucoside, cocamidopropyl betaine, sorbitan tristearate, castor oil ethoxylates, dioctyl sodium sulfosuccinate, oleylamine ethoxylate, decyl glucoside, sodium stearate, ethoxylated alcohols, sodium dioctyl sulfosuccinate, lauric acid diethanolamide, polyethoxylated tallow amine, polyethoxylated alkylphenols, PEG stearate, octylphenol ethoxylate, a combination thereof, and the like. In a preferred embodiment, the emulsifier comprises a nonionic surfactant sorbitan ester. In one preferred embodiment, the emulsifier comprises an industrial surfactant, AF-70™ (a Haliburton surfactant).

In some embodiments, the emulsified acid system has an aqueous mixture to liquid organic phase ratio of 65:35 to 75:25, preferably 66:34 to 74:26, preferably 67:33 to 73:27, preferably 68:32 to 72:28, more preferably 69:31 to 71:29, and yet more preferably about 70:80 by volume. In a preferred embodiment, the emulsified acid system has an aqueous mixture to liquid organic phase ratio of 70:30 by volume.

At step 54, the method 50 includes mixing the aqueous acid phase, a corrosion inhibitor, an inhibitor intensifier, and one or more iron controls to form a second solution. In some embodiments, the mixing may be done manually, by a stirrer, a magnetic stir bar and plate, a sonicator, a high-speed mixer, a high-shear mixer, an overhead stirrer, a homogenizer, an ultrasonic processor, a propeller agitator, a paddle mixer, a turbine mixer, a planetary mixer, a vortex mixer, an emulsification pump, a rotor-stator mixer, a static mixer, a ribbon blender, a ball mill mixer, an anchor stirrer, an inline mixer, a high-pressure homogenizer, a screw agitator, a centrifugal mixer, a peristaltic mixer, an impeller mixer, a sigma blade mixer, a double planetary mixer, a conical screw mixer, a twin-screw mixer, a kneader reactor, a disperser, a gear-driven stirrer, an orbital shaker, a combination thereof, and any mixing method and equipment known in the art. In a preferred embodiment, the aqueous acid phase, the corrosion inhibitor, an inhibitor intensifier, and one or more iron controls are mixed with a magnetic stirrer.

In some embodiments, the aqueous acid phase may include, but is not limited to, formic acid, acetic acid, phosphoric acid, citric acid, sulfamic acid, oxalic acid, tartaric acid, lactic acid, malic acid, glycolic acid, glutaric acid, butyric acid, hydrofluoric acid, hydrochloric acid, nitric acid, benzoic acid, ascorbic acid, peracetic acid, boric acid, fumaric acid, succinic acid, propionic acid, hydrochloric acid mixtures with organic acids, EDTA solutions, tartaric-formic blends, urea hydrochloride, phosphonoacetic acid, iminodiacetic acid, thioglycolic acid, ethylenediaminetetraacetic acid, a combination thereof, and the like. In a preferred embodiment, the aqueous acid phase comprises hydrochloric acid. In some embodiments, the aqueous acid phase comprises diluted hydrochloric acid. In some embodiments, the aqueous acid phase comprises hydrochloric acid and the emulsified acid system does not contain silica.

In some embodiments, a concentration of the acid is 10 to 25 grams per 100 grams of the emulsified acid system, preferably 11 to 24 grams per 100 grams of the emulsified acid system, preferably 12 to 23 grams per 100 grams of the emulsified acid system, preferably 13 to 22 grams per 100 grams of the emulsified acid system, preferably 14 to 21 grams per 100 grams of the emulsified acid system, preferably 15 to 20 grams per 100 grams of the emulsified acid system, preferably 16 to 19 grams per 100 grams of the emulsified acid system, and preferably 17 to 18 grams per 100 grams of the emulsified acid system. In a preferred embodiment, the concentration of the acid is 15 grams per 100 grams of the emulsified acid system. In another preferred embodiment, the concentration of the acid is 20 grams per 100 grams of the emulsified acid system. In some embodiments, a concentration of the acid is 10 to 25 grams per 100 grams of the emulsified acid system and the emulsified acid system does not contain silica and the only particles in the emulsified acid system are the carbon nanodots.

In some embodiments, a corrosion inhibitor may include, but is not limited to, imidazoline derivatives, quaternary ammonium compounds, propargyl alcohol, thiourea, alkynol derivatives, pyridinium salts, acetylenic alcohols, dodecylbenzene sulfonic acid, benzotriazole, sodium molybdate, alkyl pyridines, triazoles, fatty amines, polyamines, morpholine, phosphate esters, tannins, lignin amines, toluidine derivatives, sodium benzoate, polyacrylamide-based inhibitors, cinnamaldehyde derivatives, ethanolamine, hexamine, sodium nitrite, borax, oleylamine, coconut oil fatty acid amines, a combination thereof, and the like. In a preferred embodiment, the corrosion inhibitor is an industrial corrosion inhibitor, HAI-OS and/or HAI-404™ (Halliburton corrosion inhibitors).

In some embodiments, an inhibitor intensifier may include, but is not limited to, potassium iodide, thioglycolic acid, formamide, thiourea, ferrous sulfate, ferrous chloride, copper sulfate, sodium thiosulfate, sodium metabisulfite, ascorbic acid, hexamethylenetetramine (hexamine), sodium sulfite, hydrazine, zinc chloride, diethanolamine, triethanolamine, morpholine, potassium permanganate, sulfonated lignin, tolyltriazole, sodium molybdate, polyphosphates, calcium gluconate, glycerin, ethanolamine, glycol ethers, tannic acid, phenylthiourea, benzoic acid, a combination thereof, and the like. In a preferred embodiment, the inhibitor intensifier is an industrial inhibitor intensifier, HII-124F (Halliburton inhibitor intensifier).

In some embodiments, one or more iron controls may include, but is not limited to, ethylenediaminetetraacetic acid (EDTA), citric acid, ascorbic acid, thioglycolic acid, sodium erythorbate, oxalic acid, nitrilotriacetic acid (NTA), diethylenetriaminepentaacetic acid (DTPA), hydroxyethylidene diphosphonic acid (HEDP), gluconic acid, sodium gluconate, tartaric acid, malonic acid, sodium dithionite, ferrous sulfate, sodium thiosulfate, phosphonic acid derivatives, lactic acid, succinic acid, maleic acid, phosphonobutane tricarboxylic acid (PBTC), sodium hydrosulfite, polycarboxylic acids, iminodiacetic acid, citramalic acid, glutamic acid diacetic acid (GLDA), ethylenediamine disuccinic acid (EDDS), amino trimethylene phosphonic acid (ATMP), a combination thereof, and the like. In a preferred embodiment, the one or more iron controls are industrial iron controls, FE-1A and FE-2A (Halliburton iron controls).

At step 56, the method 50 includes adding the second solution to the first solution to form a third solution. In some embodiments, mixing occurs after the adding to form the third solution. In some embodiments, the mixing may be done manually, by a stirrer, a magnetic stir bar and plate, a sonicator, a high-speed mixer, a high-shear mixer, an overhead stirrer, a homogenizer, an ultrasonic processor, a propeller agitator, a paddle mixer, a turbine mixer, a planetary mixer, a vortex mixer, an emulsification pump, a rotor-stator mixer, a static mixer, a ribbon blender, a ball mill mixer, an anchor stirrer, an inline mixer, a high-pressure homogenizer, a screw agitator, a centrifugal mixer, a peristaltic mixer, an impeller mixer, a sigma blade mixer, a double planetary mixer, a conical screw mixer, a twin-screw mixer, a kneader reactor, a disperser, a gear-driven stirrer, an orbital shaker, a combination thereof, and any mixing method and equipment known in the art. In a preferred embodiment, mixing is done by the homogenizer at a speed of about 6000 revolutions per minute (RPM).

At step 58, the method 50 includes mixing carbon nanodots with the third solution to form the emulsified acid system. In some embodiments, the mixing may be done manually, by a stirrer, a magnetic stir bar and plate, a sonicator, a high-speed mixer, a high-shear mixer, an overhead stirrer, a homogenizer, an ultrasonic processor, a propeller agitator, a paddle mixer, a turbine mixer, a planetary mixer, a vortex mixer, an emulsification pump, a rotor-stator mixer, a static mixer, a ribbon blender, a ball mill mixer, an anchor stirrer, an inline mixer, a high-pressure homogenizer, a screw agitator, a centrifugal mixer, a peristaltic mixer, an impeller mixer, a sigma blade mixer, a double planetary mixer, a conical screw mixer, a twin-screw mixer, a kneader reactor, a disperser, a gear-driven stirrer, an orbital shaker, a combination thereof, and any mixing method and equipment known in the art. In a preferred embodiment, mixing is done by the homogenizer at a speed of about 6000 RPMs. In alternative embodiments, the carbon nanodots may be mixed with the aqueous acid phase, the corrosion inhibitor, an inhibitor intensifier, and one or more iron controls to form the second solution, and the second solution including the carbon nanodots is added to and mixed with the first solution to form the emulsified acid system.

FIG. 1B illustrates a schematic flow chart of a method 70 of preparing the carbon nanodots. The order in which the method 70 is described is not intended to be construed as a limitation, and any number of the method described can be combined in any order to implement the method 70. Additionally, individual steps may be removed or skipped from the method 70 without departing from the spirit and scope of the present disclosure.

At step 72, the method 70 includes mixing citric acid and ethanolamine to form a solution. In some embodiments, the citric acid may include, but is not limited to, trisodium citrate, citric acid monohydrate, citric acid anhydrous, potassium citrate, calcium citrate, ferric ammonium citrate, magnesium citrate, zinc citrate, sodium hydrogen citrate, ammonium citrate, manganese citrate, aluminum citrate, bismuth citrate, copper citrate, iron citrate, lithium citrate, cobalt citrate, nickel citrate, strontium citrate, lanthanum citrate, sodium ferric citrate, citric acid esters, citric acid lactone, monoethyl citrate, citric acid phosphate blends, citric acid-sorbitol complexes, citrate-buffered solutions, citrate chelates with rare earth metals, combinations thereof, and the like.

In some embodiments, the ethanolamine may include, but is not limited to, monoethanolamine (MEA), diethanolamine (DEA), triethanolamine (TEA), 2-aminoethanol, ethanolamine hydrochloride, ethanolamine oleate, ethanolamine nitrate, ethanolamine phosphate, ethanolamine sulfate, ethanolamine stearate, ethanolamine citrate, ethanolamine borate, N-methylethanolamine, N,N-dimethylethanolamine, ethanolamine acetate, ethanolamine laurate, ethanolamine carbonate, ethanolamine formate, ethanolamine oxalate, ethanolamine tartrate, ethanolamine succinate, ethanolamine silicate, ethanolamine glycolate, ethanolamine thioglycolate, ethanolamine butyrate, ethanolamine palmitate, ethanolamine malate, ethanolamine gluconate, ethanolamine-based surfactants, a combination thereof, and the like.

At step 74, the method 70 includes heating the solution to a temperature of 400 to 500° C., preferably 410 to 490° C., preferably 420 to 480° C., preferably 430 to 470° C., and more preferably 440 to 460° C. for 20 to 40 minutes, preferably 22 to 38 minutes, preferably 24 to 36 minutes, preferably 26 to 34 minutes, and more preferably 28 to 32 minutes to form a product. In a preferred embodiment, the solution is heated to a temperature of about 450° C. for about 30 minutes to form the product.

At step 76, the method 70 includes mixing the product in water to form a dispersion. In some embodiments, the mixing may be done manually, by a stirrer, a magnetic stir bar and plate, a sonicator, a high-speed mixer, a high-shear mixer, an overhead stirrer, a homogenizer, an ultrasonic processor, a propeller agitator, a paddle mixer, a turbine mixer, a planetary mixer, a vortex mixer, an emulsification pump, a rotor-stator mixer, a static mixer, a ribbon blender, a ball mill mixer, an anchor stirrer, an inline mixer, a high-pressure homogenizer, a screw agitator, a centrifugal mixer, a peristaltic mixer, an impeller mixer, a sigma blade mixer, a double planetary mixer, a conical screw mixer, a twin-screw mixer, a kneader reactor, a disperser, a gear-driven stirrer, an orbital shaker, a combination thereof, and any mixing method and equipment known in the art. In a preferred embodiment, mixing is done by a magnetic stirrer.

At step 78, the method 70 includes dialyzing the dispersion against water to form the carbon nanodots. In some embodiments, water may include but is not limited to distilled water, tap water, reverse osmosis water, ultrapure water, rainwater, well water, spring water, mineral water, softened water, double-distilled water, borehole water, potable water, filtered water, hard water, softened municipal water, carbonated water, sterile water, hot water, cold water, warm water, brackish water, greywater, lake water, river water, seawater, glacier water, underground water, stormwater, purified water, and aquifer water. In a preferred embodiment, water is deionized water.

In some embodiments, the emulsified acid system includes carbon nanodots in an amount range from 0.3 to 0.5 vol. %, preferably 0.31 to 0.49 vol. %, preferably 0.32 to 0.48 vol. %, preferably 0.33 to 0.47 vol. %, preferably 0.34 to 0.46 vol. %, preferably 0.35 to 0.45 vol. %, preferably 0.36 to 0.44 vol. %, preferably 0.37 to 0.43 vol. %, preferably 0.38 to 0.42 vol. %, more preferably 0.39 to 0.41 vol. %, and yet more preferably about 0.4 vol. % based on a total volume of the emulsified acid system.

In some embodiments, the carbon nanodots have a diameter of 2 to 4 nm, preferably 2.2 to 3.8 nm, preferably 2.4 to 3.6 nm, preferably 2.6 to 3.4 nm, and preferably 2.8 to 3.2 nm.

In some embodiments, carbon nanodots include carbon in an amount of 78 to 82 wt. %, preferably 78.5 to 81 wt. %, preferably 79 to 80 wt. %, and more preferably 79.1 to 79.5 wt. % and oxygen in an amount of 18 to 22 wt. %, preferably 18.5 to 21.5 wt. %, preferably 19 to 21 wt. %, and more preferably 20 to 20.9 wt. % based on the total weight of the carbon nanodots. In a preferred embodiment, carbon nanodots include carbon in an amount of about 79.2 wt. % and oxygen in an amount of about 20.8 wt. % based on the total weight of the carbon nanodots.

The following examples are provided solely for illustration and are not to be construed as limitations of the present disclosure, as many variations thereof are possible without departing from the spirit and scope of the present disclosure.

### EXAMPLES

The following examples describe and demonstrate a method of well injection with reduced drag using an emulsified acid system as described herein. The examples are provided solely for illustration and are not to be construed as limitations of the present disclosure, as many variations thereof are possible without departing from the spirit and scope of the present disclosure.

### Example 1: Materials and Equipment

Materials utilized in this disclosure include lab-grade hydrochloric acid (HCl) with 37 weight percent (wt. %) concentration, industrial-grade hydrochloric acid (HCl) with 26 wt. % concentration, de-ionized (DI) water, commercial diesel from a gas station, EAS formula including one corrosion inhibitor, one inhibitor intensifier, two iron controls, and one emulsifier (surfactant). Equipment to perform this experiment includes high shear mixer/homogenizer [IKA T 25 digital ULTRA-TURRAX homogenizer with titanium acid-resistant shaft and speed range of 3000-25,000 revolutions per minute (RPM)], magnetic stirrer, rheometer (Anton-Paar MCR-702 Rheometer), see-through oven, test tubes, conductivity and pH meter (Thermo Scientific-Orion Star A215 pH/conductivity benchtop multiparameter meter), high-speed mixer/homogenizer (TAISITESMART JRJ-300SH-220 V high-speed homogenizer lab disperser emulsifier capacity 40 L 200-11000 RPM 510 W digital display blender), drag reduction unit (flow loop).

### Example 2: Emulsified Acid System (EAS) Preparation

EAS was prepared based on the commercial formula with the ratio of 70:30 acid-to-diesel ratio, where 70% is the ratio of the aqueous phase or acid phase (dispersed phase), while 30% is the ratio of the diesel phase, representing the continuous or external phase. The concentrations of HCl acid in the EAS were 15% and 20%. Firstly, the emulsifier (surfactant) was added with a specific concentration according to the formula to the diesel, and they were mixed using the homogenizer at 6000 RPM for 2-3 minutes, while the 37% lab-grade HCl acid was titrated with DI water in a separate beaker to the concentration of 15% and 20% using a magnetic stirrer for 1-2 minutes. Then, the corrosion inhibitor was added in an amount of 6 gallons (gal) per 1000 gallons of the emulsified acid system, as shown in Table 1, to the aqueous phase during mixing by the magnetic stirrer. Similarly, the inhibitor intensifier and iron controls (2) were added to the aqueous phase in an amount of 10 gal/1000 gal, 10/1000 gal, and 50 pounds (lbs)/1000 gal, respectively, during mixing by the magnetic stirrer. After that, the aqueous phase (acid phase) was added to the oil phase (diesel phase) progressively while mixing at 6000 RPM.

TABLE 1
Emulsified Acid System Formulation

| Additive | Concentration | Units |
|---|---|---|
| Fresh Water | 237 | gal/1000 gal |
| 31% Hydrochloric Acid | 429 | gal/1000 gal |
| HAI-OS, Corrosion Inhibitor | 6 | gal/1000 gal |
| HII-124F, Inhibitor Intensifier | 10 | gal/1000 gal |
| FE-1A, Iron Control | 10 | gal/1000 gal |
| FE-2, Iron Control | 50 | lbs/1000 gal |
| Diesel | 294 | gal/1000 gal |
| AF-70, Emulsifier | 6 | gal/1000 gal |

### Example 3: Synthesis Procedure for Carbon-Nanodots

A mixture of citric acid and ethanolamine was mixed in an open container (beaker). The beaker was then placed in an oven and heated to the desired temperature of 450° C. for a duration of 30 minutes. Afterward, the products were dispersed in deionized (DI) water, and the aqueous dispersion was introduced into a SnakeSkin Pleated Dialysis Tubing membrane [with a molecular weight cutoff of 3500 dalton (Da)]. The mixture was dialyzed against DI water for several days to remove impurities and any unreacted materials. The water was changed every 8 hours, for at least one week. Finally, the sample in the dialysis tube was concentrated using gentle heat (40-50° C.) in a water bath to avoid direct heat exposure.

### Example 4: Conductivity/pH, and Drop Test

Electrical conductivity was measured for the prepared EAS to ensure that the prepared EAS is a water/oil (W/O) emulsion (the external phase is diesel). If the electrical conductivity reading is close to zero, a W/O emulsion is indicated. A drop-test was performed to confirm that the EAS is a W/O emulsion. The drop test was performed by putting 1 mlL of the prepared EAS in 20 mL of water and 20 mL of diesel in two separate beakers. The emulsion is an O/W emulsion if the dispersion takes place in a beaker containing water, while the emulsion is a W/O emulsion if it takes place in a beaker containing diesel. To confirm the acidity of the prepared EAS, the pH was measured.

### Example 5: Thermal Stability

Thermal stability is used to determine that the prepared EAS reaches the formation in its original form. Thermal stability was explored at three different temperatures (25° C., 80° C., and 120° C.) using high-temperature graduated glass tubes and a see-through oven. By visually observing the EAS separation every 10 minutes for the first 30 minutes, then every hour after the first 30 minutes for the next 2-3 hours, and finally after 24 hours, thermal stability was carried out. The EAS separation volume was plotted against the time, and photographs of the graduated glass tubes were taken before and after heating in the oven.

### Example 6: Rheology

Rheological properties were assessed using the Annton Paar rheometer MCR-702, which has an acid-resistant bob/cup setup. A 15.9 mL volume of the prepared EAS is used in the setup. All rheology measurements were performed at 65° C. Every test took two hours, while the shear rate ranged from 0.1 1/sec to 1000 1/sec.

### Example 7: Flow Experiment

The EAS was prepared based on the commercial formula as the base case with large amounts (30 liter-40 liter) for one flow experiment. After that, the prepared EAS was pumped through the flow loop (drag reduction unit). The flow loop consisted of a gear pump with a variable frequency drive (VFD), tank, pressure transducer, and flow meter. The flow loop is equipped with a heating system to heat and control the temperature of the fluid throughout the experiment. Once a set of experiments at various flow rates at a fixed temperature is completed the temperature is changed and another set of experiments is generated covering a range of temperatures. Once the fluid attains a temperature the flow rate of the system is adjusted using the variable frequency drive and the reading of a pressure drop against flow rates is recorded. This procedure is followed covering the range flow rates starting from low to high and then high to low to check the hysteresis. Similarly, the flow experiment was again repeated after adding carbon nanodots (CNDs). The flow experiments were done for two different HCl concentrations EAS (15% and 20%) before and after adding CNDs.

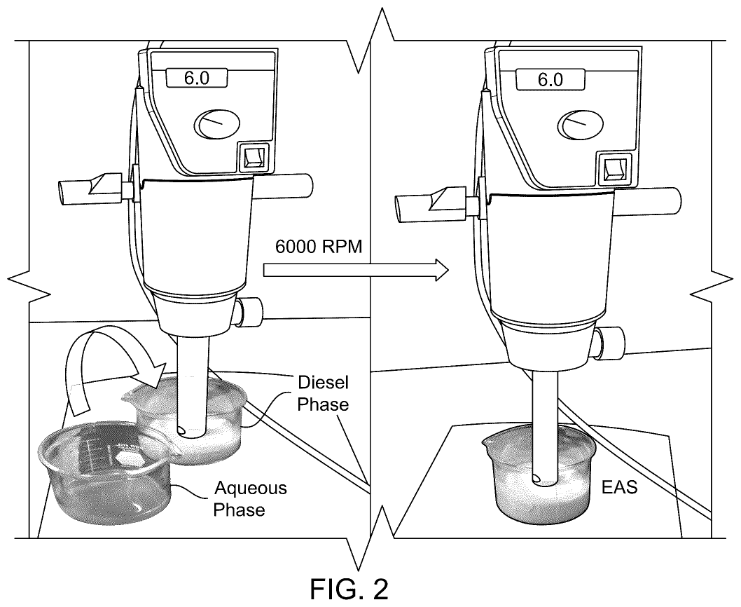

The EAS was prepared with the ratio of 70:30 acid-to-diesel ratio based on the commercial formula as the base case, where the HCl acid concentration in the EAS was 15%. The emulsifier (surfactant) was added to the diesel and mixed using the homogenizer at 6000 RPM for 2-3 minutes. The 37% lab-grade HCl acid was titrated with DI water in a separate beaker to the concentration of 15% using a magnetic stirrer for 1-2 minutes. The corrosion inhibitor was added to the aqueous phase during mixing by the magnetic stirrer. Similarly, the inhibitor intensifier and iron controls were added to the aqueous phase during mixing by the magnetic stirrer. After that, the aqueous phase (acid phase) was added to the oil phase (diesel phase) progressively while mixing at 6000 RPM. Then, the prepared EAS was tested for thermal stability at different temperatures (25° C., 80° C., and 120° C.). FIG. 2 depicts EAS preparation by adding the aqueous phase to the diesel phase while mixing at 6000 RPM. The same preparation procedures were followed for EAS with 20% HCl acid concentration.

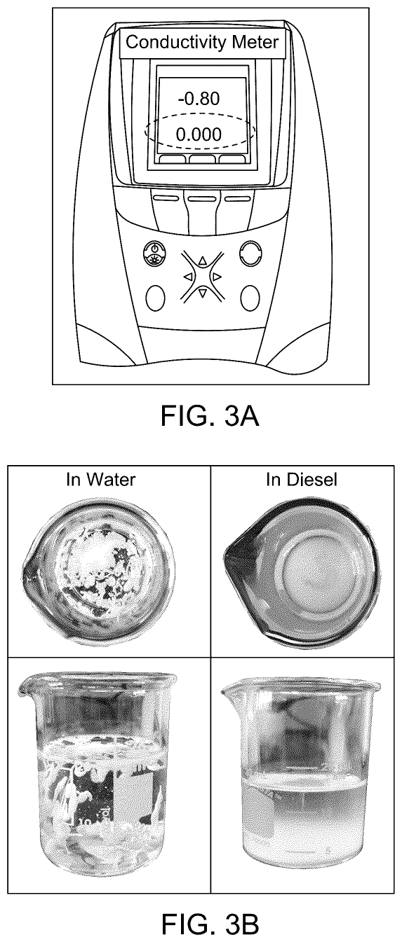

The conductivity/pH meter was used to measure the electrical conductivity and the acidity of the prepared EAS. In addition, the drop-test was carried out to ensure that the EAS is a W/O emulsion. The electrical conductivity results show values close to zero, indicating that the external phase is diesel and the prepared EAS is a W/O emulsion. According to pH measurements, the EAS is an acidic solution. The drop-test results show that the EAS is a W/O emulsion. The water phase is dispersed in diesel, and the diesel phase is not dispersed in the water. FIGS. 3A-3B depict the electrical conductivity and acidity measurement for the EAS and the drop-test in water and diesel.

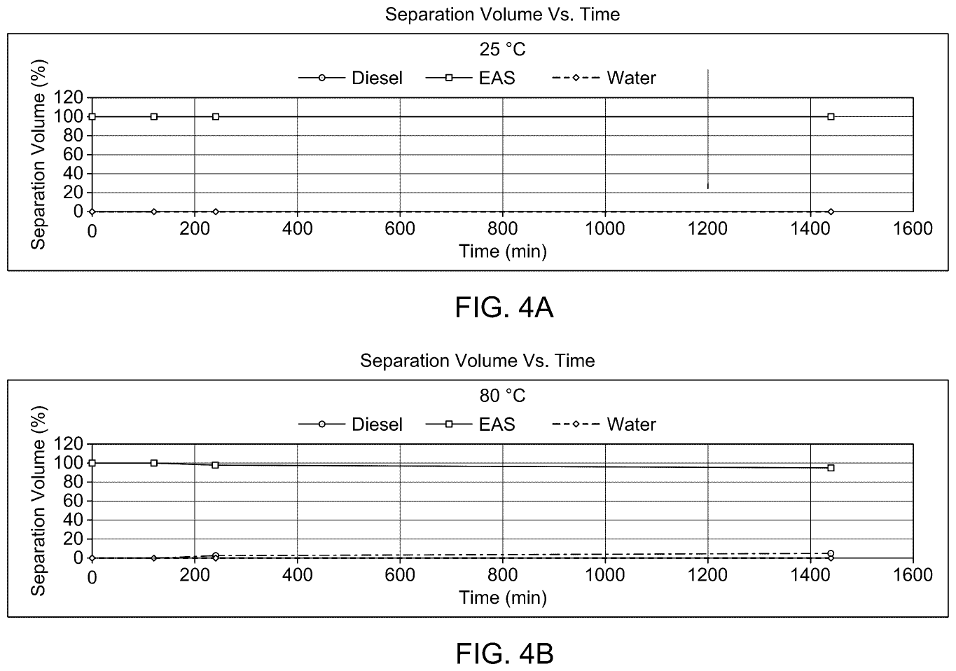

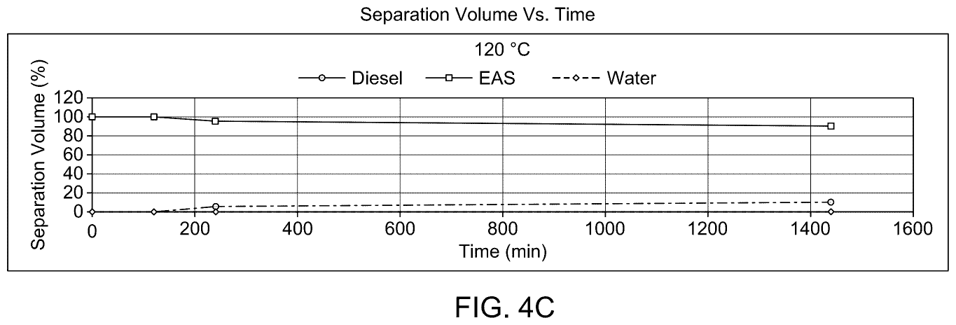

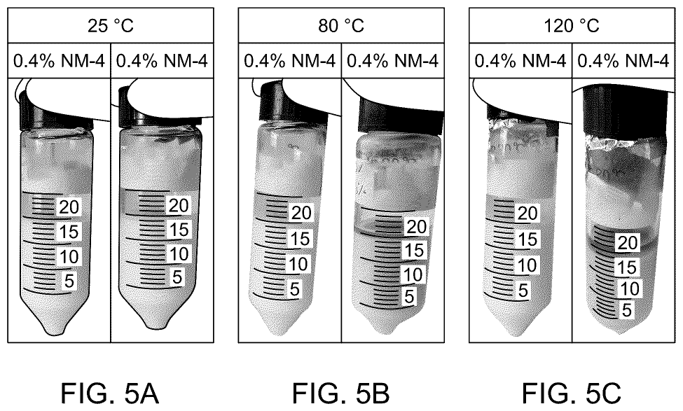

High-temperature graduated glass tubes were utilized to explore the thermal stability at three different temperatures (25° C., 80° C., and 120° C.), and a see-through oven was used to measure the thermal stability at 80° C. and 120° C. The outcomes demonstrated that even at high temperatures, the EAS is thermally stable. FIGS. 4A-4C depict the separation volume as a function of time for the EAS at the three different temperatures (25° C., 80° C., and 120° C.). FIGS. 5A-5C depict photographs of the EAS in test tubes before and after being placed in an oven for 24 hours.

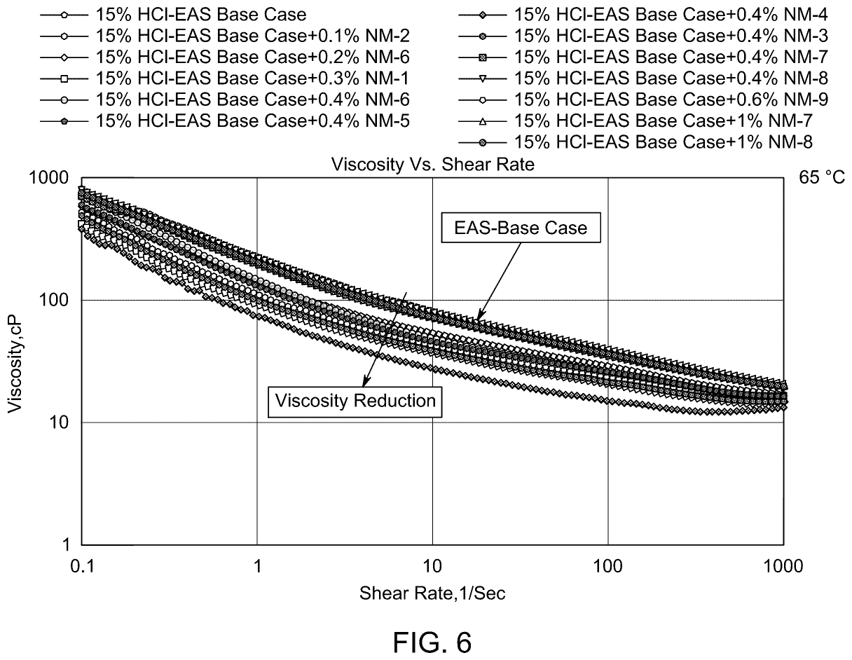

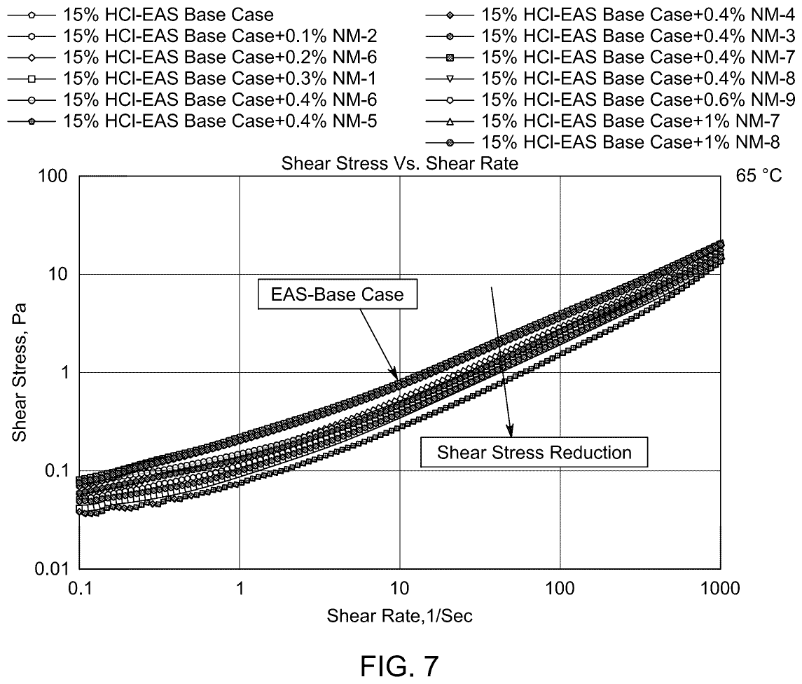

Rheological properties were explored for the prepared EAS. Firstly, the viscosity was measured at different shear rates ranging from 0.1 to 1000 sec⁻¹ at 65° C. for the prepared EAS with and without nanomaterials (NMs) (i.e., the CNDs) at 15% HCl acid concentrations, as shown in FIG. 6. Adding CNDs to the EAS reduces the viscosity, as shown in FIG. 6, while adding CNDs has a negligible effect on the EAS pH, conductivity, and thermal stability. The best nanomaterial concentration was determined to be 0.4 percent by volume (vol. %) of NM-4 and more investigation was conducted on the NM-4. FIG. 7 depicts shear stress as a function of shear rate for the prepared EAS with CNDs. NM-4 represents nanomaterial number 4. It's a type of carbon nanodots. NM-4 is CNP500 (which is CNP300 heated to 300° C. for 1 hour with reflux), as seen in Table 2 and Table 3.

TABLE 2
C-dot samples utilized in drag reduction analysis

| Sample name | CND sample |
|---|---|
| NM-1 | CNP 180 |
| NM-2 | CNP 230 |
| NM-3 | CNP 300 |
| NM-4 | CNP 500 |
| NM-5 | CNP 230 ½ HAc |
| NM-6 | CNP 230 24 autoclave |

TABLE 3
Overview of synthesized samples. All samples were
synthesized from CA and EA in the molar ratio

| Sample name | Synthesis |
|---|---|
| CNP 180 | 180° C., 30 min. with reflux, then 180° C., 30 min. without. |
| CNP 230 | 180° C., 30 min. with reflux, then 230° C. without. |
| CNP 230 ½ HAc | Same as CNP 230, but with an adjusted molar ratio of HAc and |
| | CA. |
| CNP 230 ½ HAc | An adjusted molar ratio of HAc and CA 24 h in an autoclave at 230 |
| autoclave | ° C. |
| CNP 230 24 h autoclave | 230° C. in an autoclave. |
| CNP 300 | CNP 230 heated to 300° C. for 1 hour with reflux. |
| CNP 500 | CNP 300 heated to 500° C. for 1 hour with reflux. |

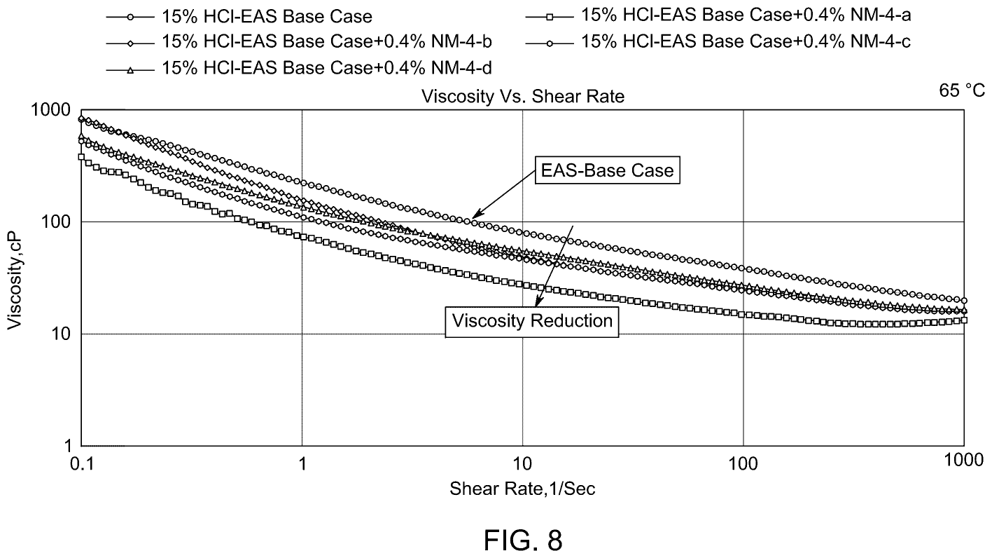

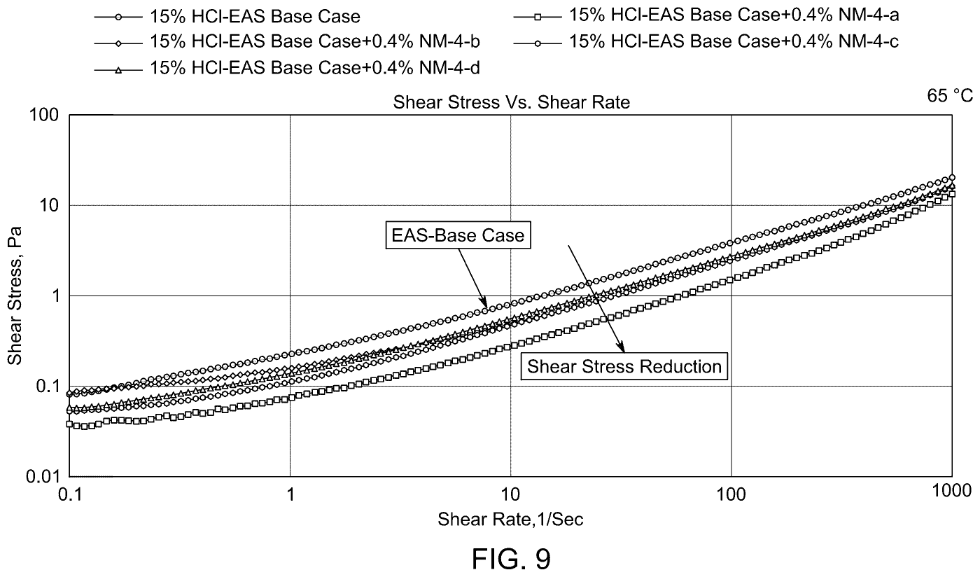

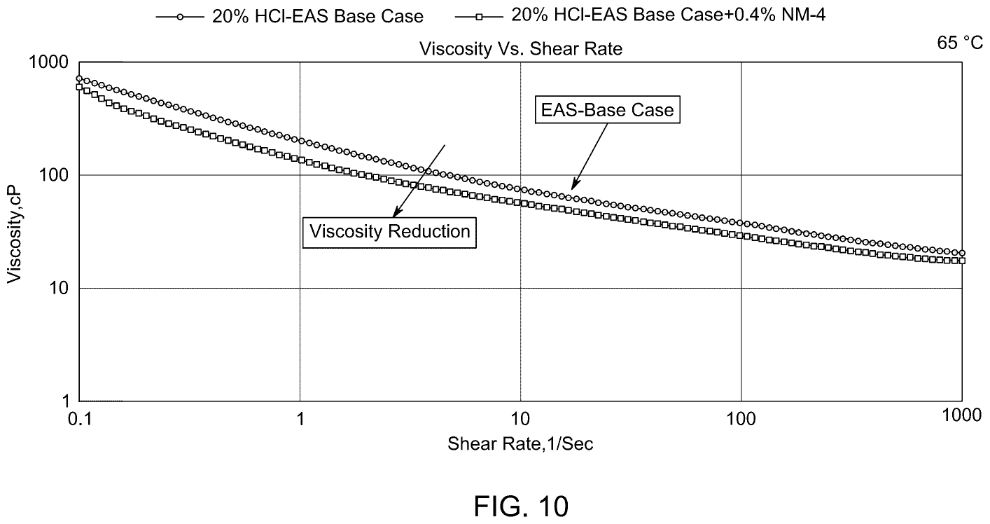

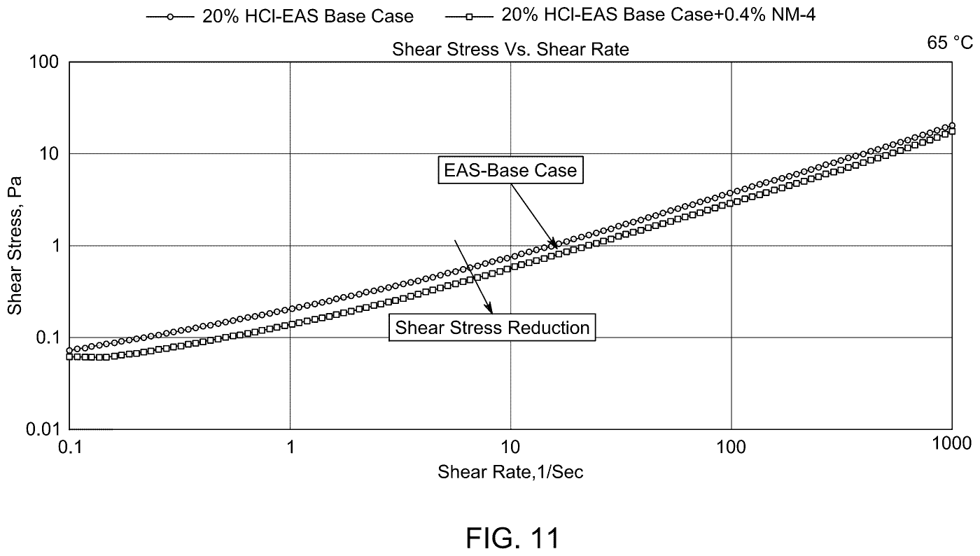

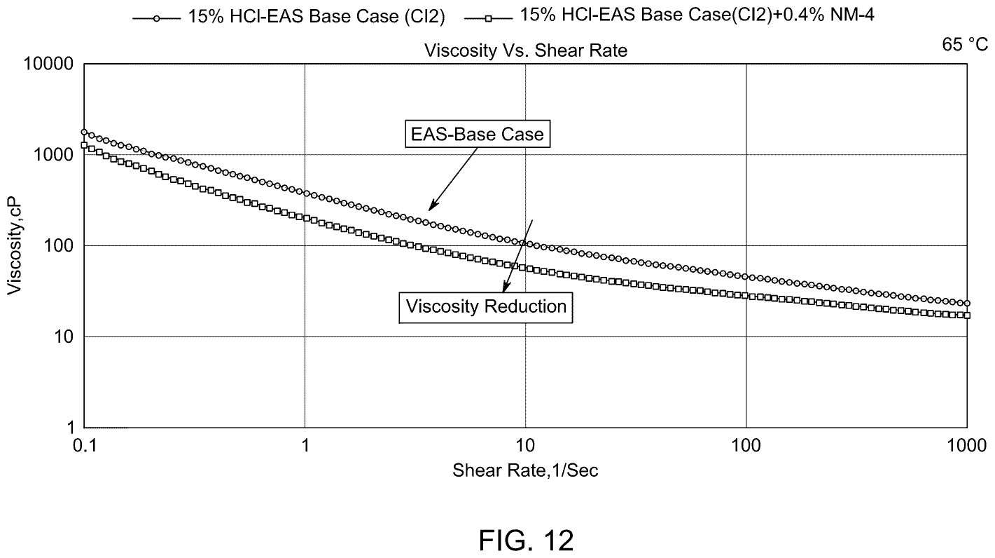

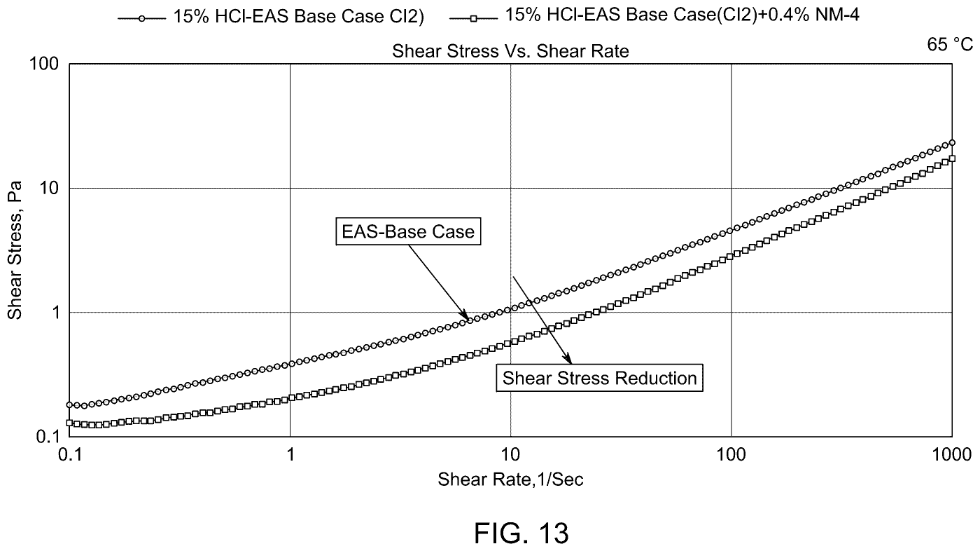

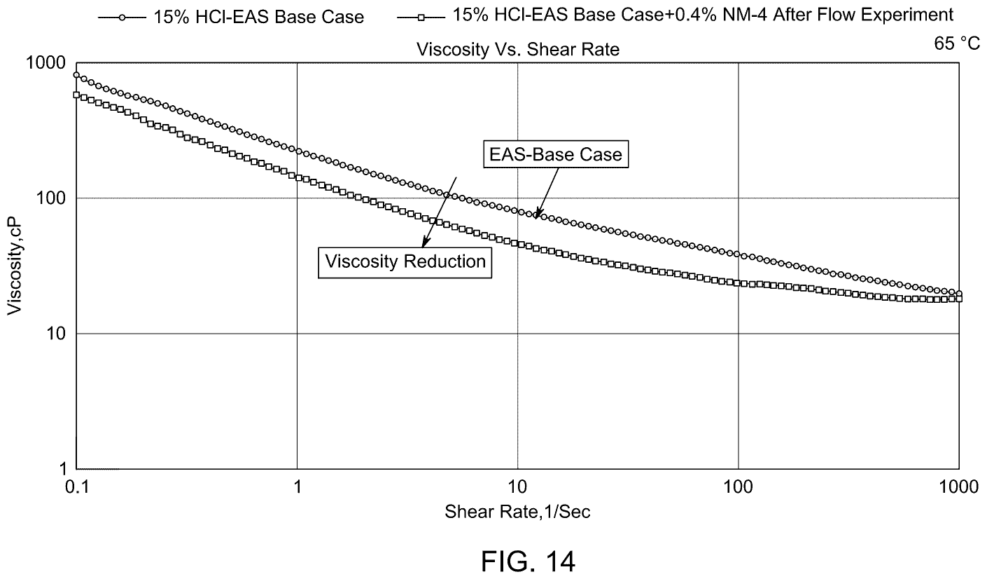

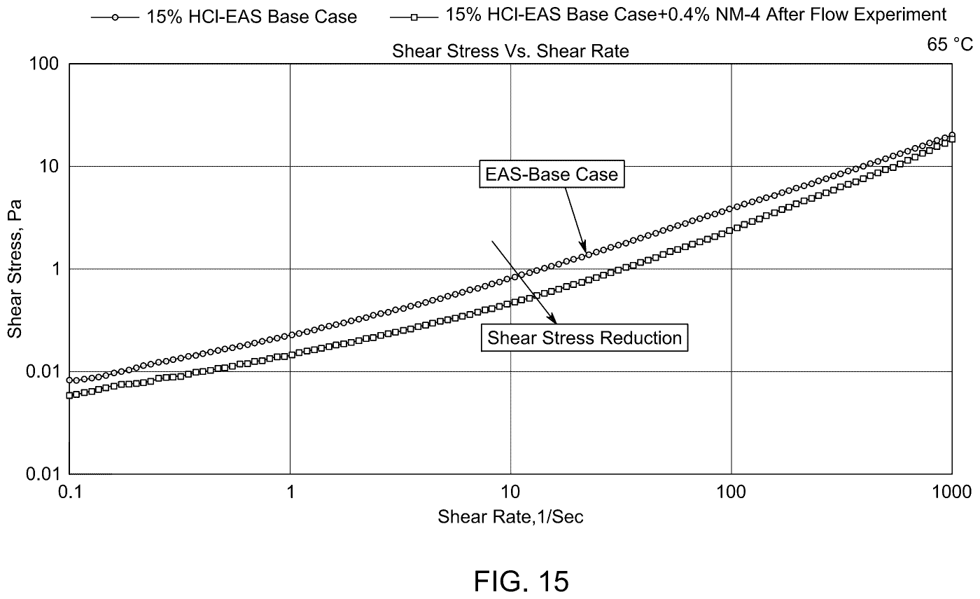

All experiments (preparation, conductivity, drop-test, thermal stability, and rheology) were repeated three times (at 15% HCl) to ensure repetition. FIGS. 8-9 depict viscosity and shear stress as a function of shear rate, respectively, for the prepared EAS. The same nanomaterial (NM-4) was tested with 20% HCl EAS, and the viscosity and shear stress as a function of the shear rate are shown in FIGS. 10-11, respectively. NM-4 was tested with another corrosion inhibitor, and the viscosity and shear stress as a function of the shear rate are shown in FIGS. 12-13, respectively. A sample was taken from the flow loop after the flow experiment of EAS with NM-4, and the viscosity was compared with the base case, as shown in FIG. 14. FIG. 15 depicts the comparison of shear stress as a function of shear rate for the two samples—the base case and the sample that was taken from the flow loop after the flow experiment.

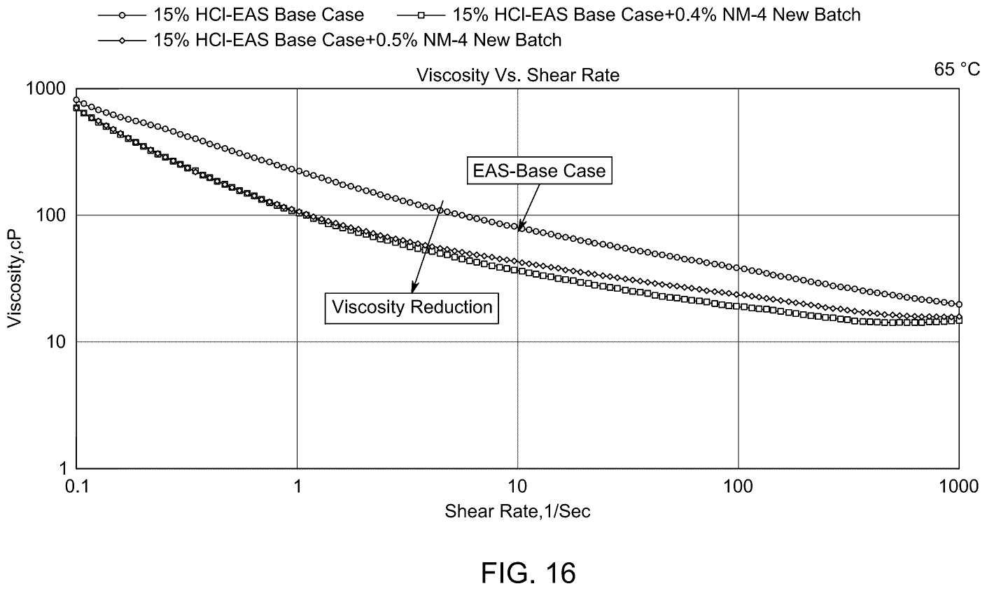

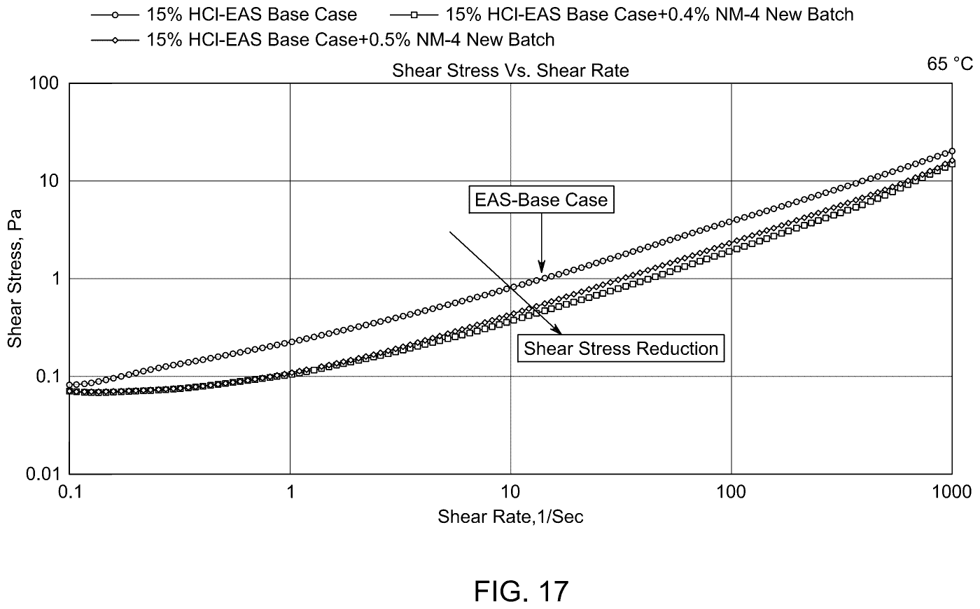

FIGS. 6, 8, 10, 12, and 14 depict that adding nanomaterials (CNDs) reduces the viscosity of the EAS at different conditions, including different HCl acid concentrations, different corrosion inhibitors, and the sample of EAS after the flow experiment. Furthermore, all experiments (preparation, conductivity, drop-test, thermal stability, and rheology) were repeated (at 15% HCl) with another batch of the same nanomaterial (NM-4) at the same concentration (0.4%). FIGS. 16-17 depict rheology results of the new batch of NM-4, which shows that adding CNDs reduces the viscosity of the EAS.

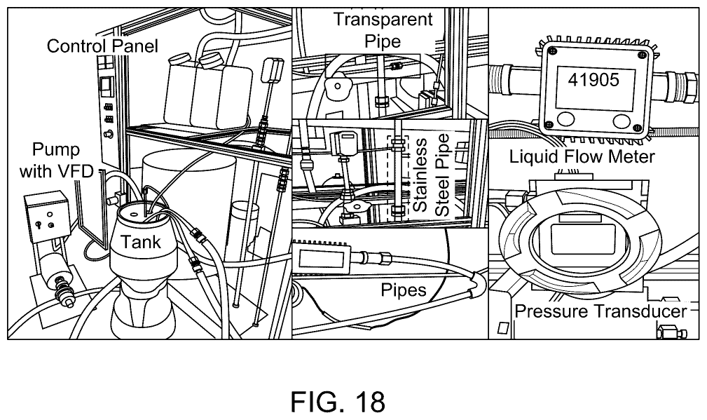

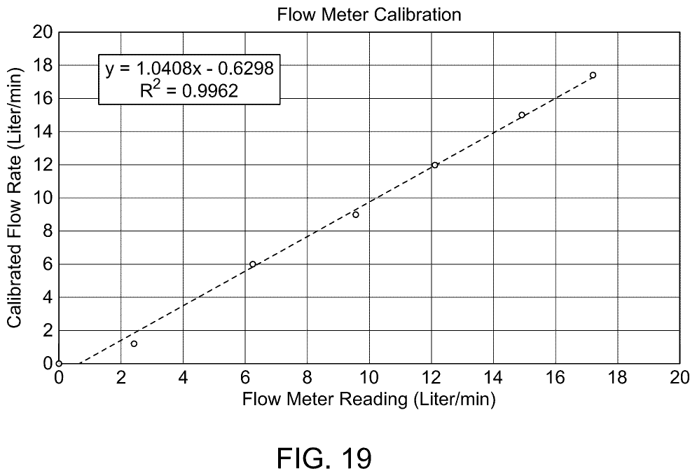

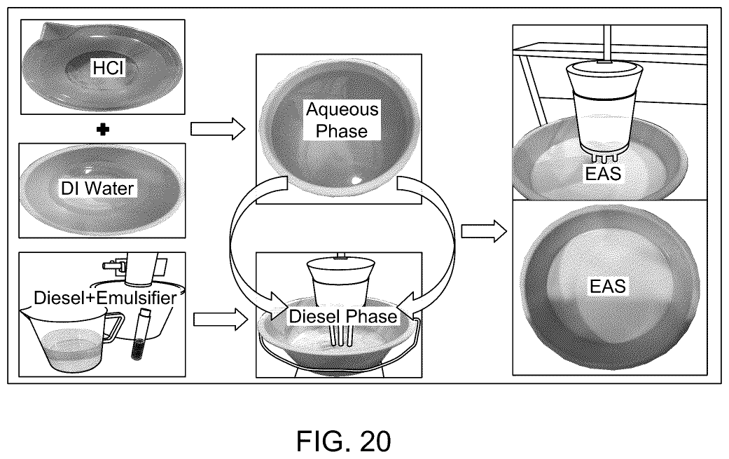

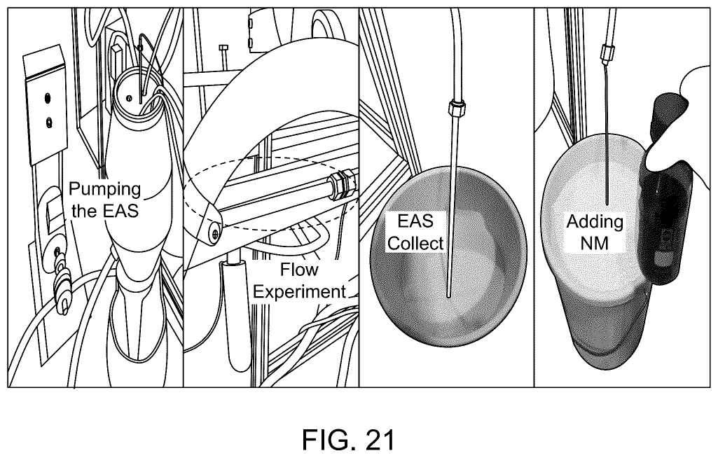

The drag reduction unit (flow loop), shown in FIG. 18, was utilized to conduct drag reduction experiments. Before using the flow loop, the drag reduction unit was calibrated with diesel, as shown in FIG. 19. The EAS was then prepared in large quantities (30-40 liters), as shown in FIG. 20. After that, the prepared EAS was pumped through the flow loop and the pressure drop was recorded using a pressure transducer at different flow rates. FIG. 21 depicts procedures of the EAS flow experiment through the drag reduction flow loop.

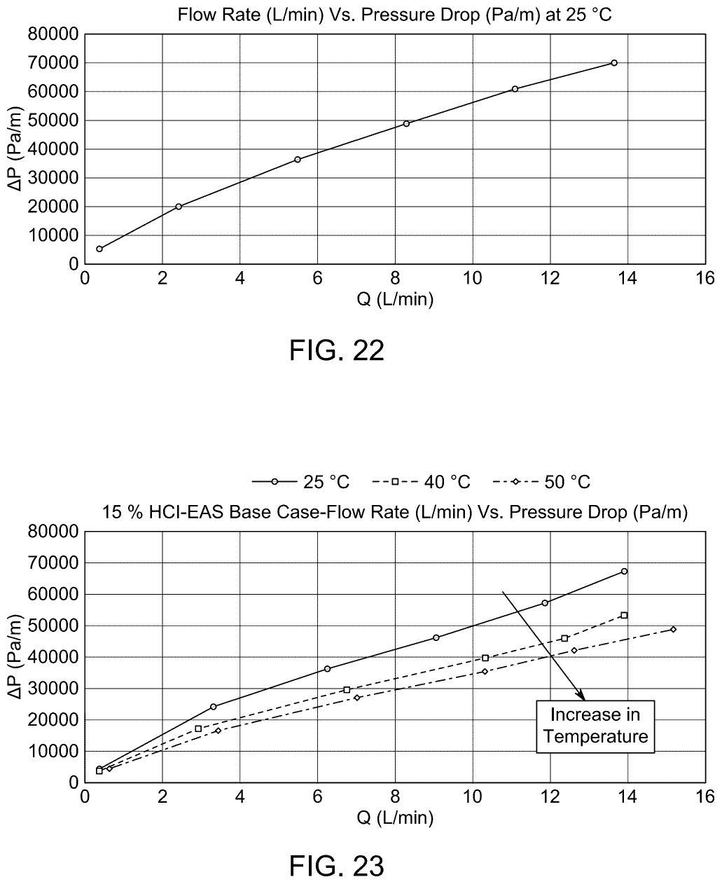

Two different HCl concentrations of the EAS were investigated in the flow experiments (15% and 20%). The pressure drop of the base case of 15% HCl-EAS was plotted against the flow rates at ambient temperature (25° C.), as shown in FIG. 22. FIG. 22 shows that pressure drop increases with an increase in the flow rate; however, the increase in pressure drop with flow rate is non-linear, hence the EAS is classified as a non-Newtonian fluid. The pressure drop (shear stress) and flow rate (shear rate) show the shear thinning behavior of EAS. The shear stress decreases with an increase in shear rate, attributed to the shear thinning behavior.

Effect of temperatures on the flow behavior of the EAS is shown in FIG. 23 (15% HCl-EAS (base case)). FIG. 23 shows that an increase in temperature causes a reduction in the pressure drop. Changes in the viscosity at high temperatures are minimal. For a constant rate of 10 L/min, the pressure gradient is 50,000 Pa/m at 25° C., 38,000 Pa/m at 40° C., and 35,000 Pa/m at 50° C. Changes in viscosity of EAS are not impacted at high temperatures. These results are consistent with the results from rheology experiments, where a reduction in the viscosity of EAS was observed with an increase in temperature.

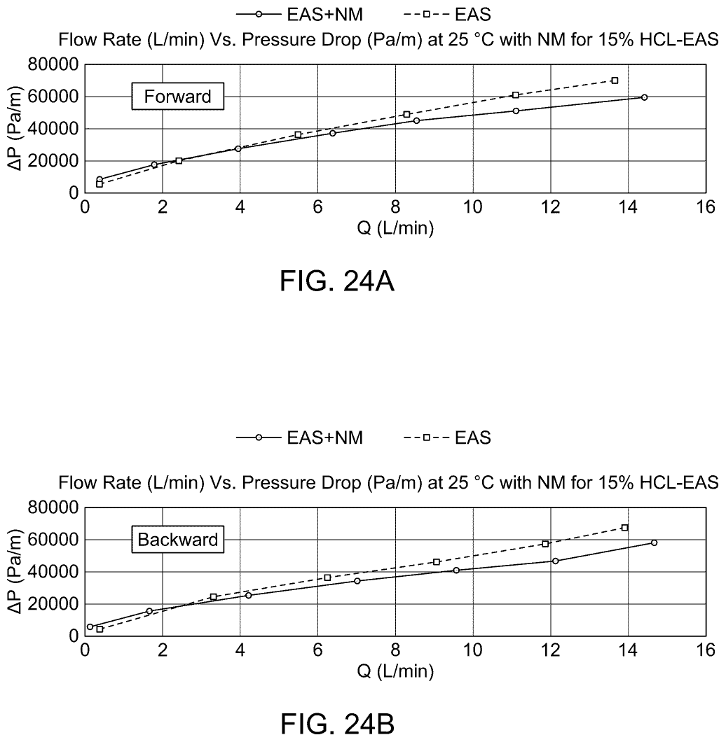

FIGS. 24A-24B shows depict reduction of the EAS with the aid of NM (i.e., the CNDs). FIGS. 24A-24B depict that the reduction of drag occurs for the EAS for the base case at 25° C. at both forward and backward flow rates. Initially, the experiment for the base case was performed for a range of flow rates and temperatures. Then NMs (i.e., the CNDs) were added to the solution of the base case 15% HCl-EAS, and the solution was pumped again through the drag reduction flow loop and the pressure drop of the solution was recorded at different flow rates. The set of flow experiments was performed to cover a range of flow rates and temperatures.

FIGS. 24A-24B depict that drag reduction may be achieved by the addition of CNDs to the EAS. The magnitude of drag reduction is larger at higher flow rates compared to the lower flow rates. At the flow rate of 10 L/min, the drag reduction was ˜8000 Pa while at 12 L/min it was ˜12,000 psi was observed.

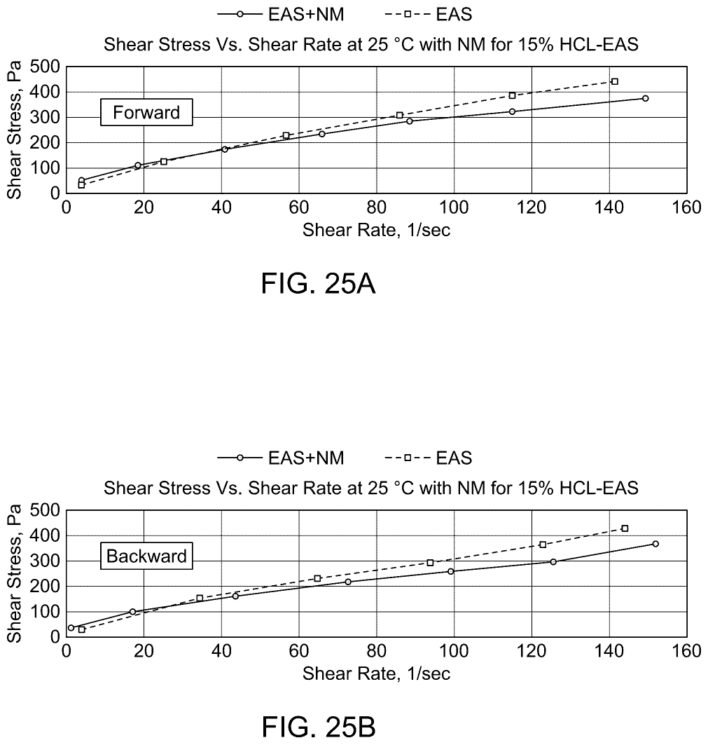

FIGS. 25A-25B depict shear stress as a function of shear rate for the EAS for the base case at 25° C. at both forward and backward flow rates, respectively. FIGS. 25A-25B depict that drag reduction may be achieved by the addition of CNDs to the EAS.

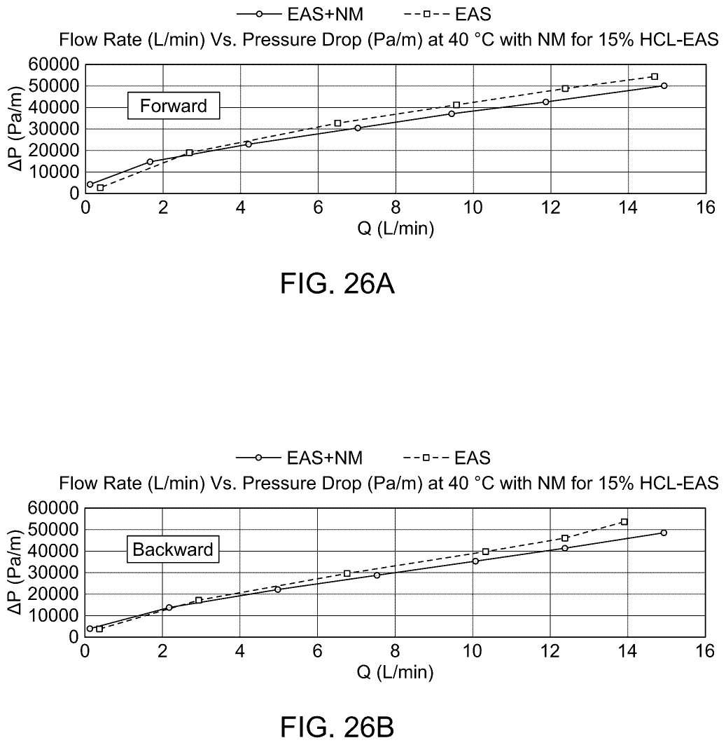

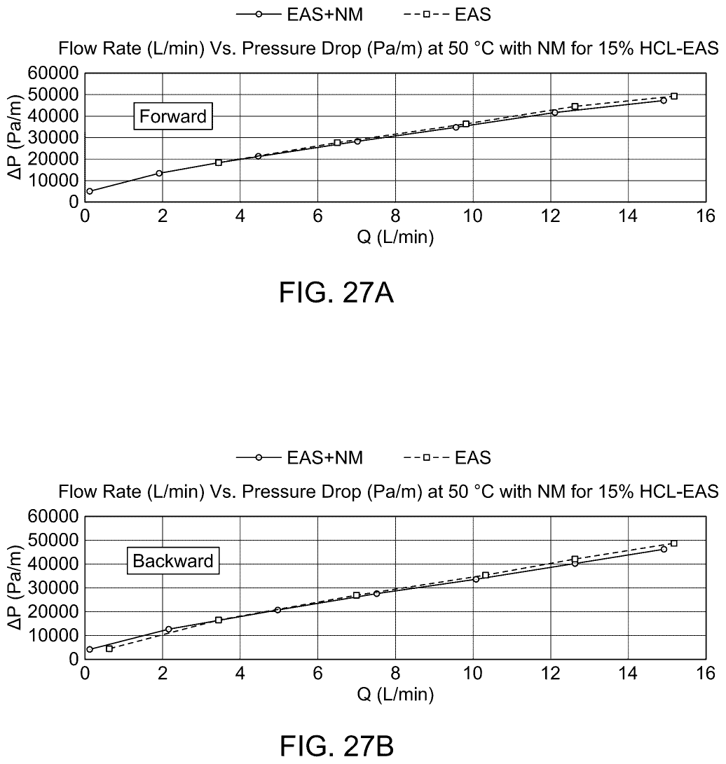

Flow experiments of the 15% HCl-EAS+NM was conducted at higher temperatures (40° C. and 50° C.) as shown in FIGS. 26A-26B and FIGS. 27A-27B, respectively. Addition of the CNDs at the higher temperatures helps in drag reduction. The magnitude of the drag reduction was decreased with an increase in temperature. Adding CNDs to the 15% HCl-EAS reduces the drag at 40° C., while the drag reduction was small at 50° C. At higher temperatures the pressure drop/viscosity values of EAS acid are lower compared to the base case; however, the trends show higher drag reduction with an increase in flow rates.

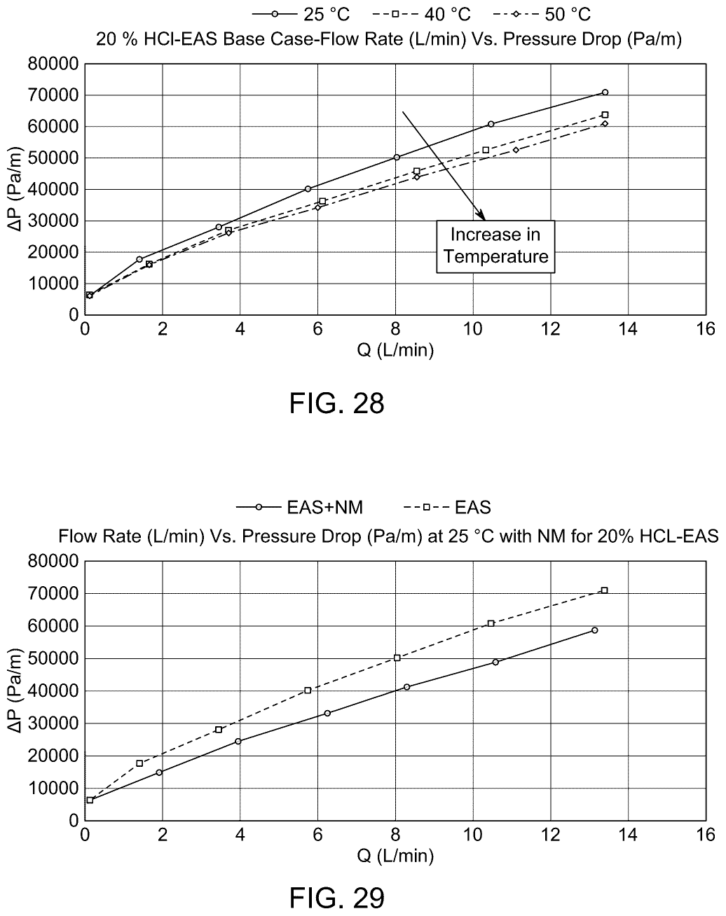

A flow experiment for the 20% HCl-EAS before and after adding CNDs was conducted using the drag reduction flow loop covering a range of flow rates and temperature comparable to the 15% HCL EAS. The effect of increasing the temperatures on the flow experiment of 20% HCl-EAS (base case) is shown in FIG. 28. An increase in temperature causes a reduction in the pressure drop. The results of the 20% HCL EAS are similar to the 15% HCL EAS; however, there is a minor alteration in the pressure drop and/or drag reduction due to an increase in the concentration of HCL. The NM (CNDs) was added to the base case of 20% HCl-EAS and the solution was pumped through the drag reduction flow loop again and the pressure drop of the solution was recorded at different flow rates and temperatures.

FIG. 29 depicts a comparison between the pressure drop of 20% HCl-EAS before and after adding the NM at 25° C. Adding the NM to the EAS reduced the drag at ambient temperature (25° C.), particularly at high flow rates.

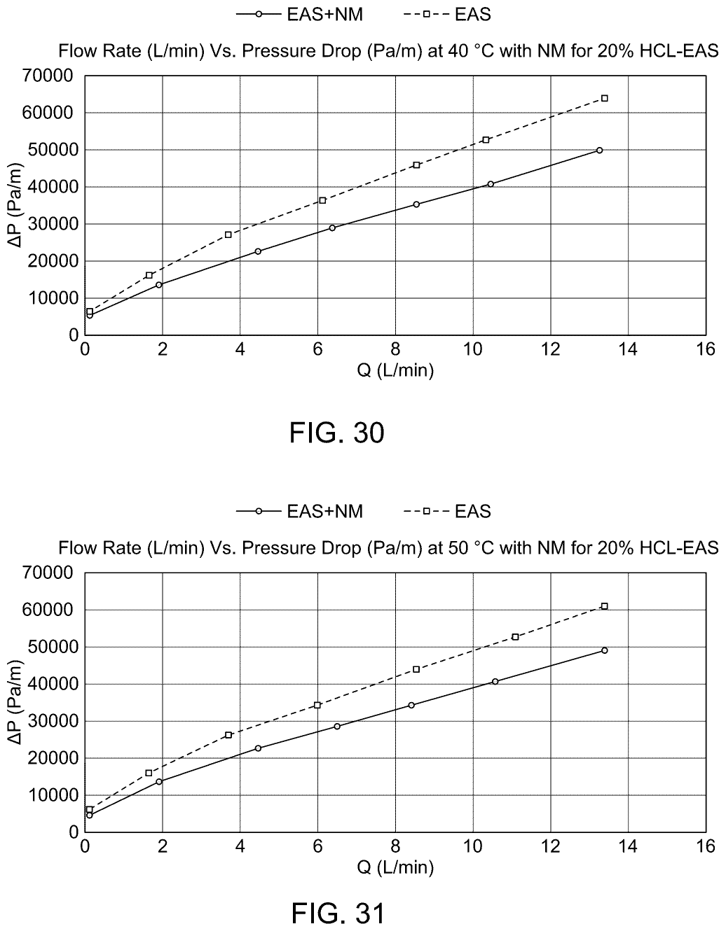

Flow experiments of the 20% HCl-EAS+NM was done at higher temperatures (40° C. and 50° C.), as shown in FIGS. 30-31, respectively. Addition of the NMs to the 20% HCl-EAS reduces the drag at 40° C. and 50° C. The trends in drag reduction are similar to the base case of 15% HCL emulsion (i.e., reduction of drag is larger at high flow rates). In addition, the effect of drag reduction is retained at high temperatures where the viscosities and/or pressure values are lower. It further strengthens the use of CNDs for achieving drag reduction of an EAS irrespective of viscosity and temperature.

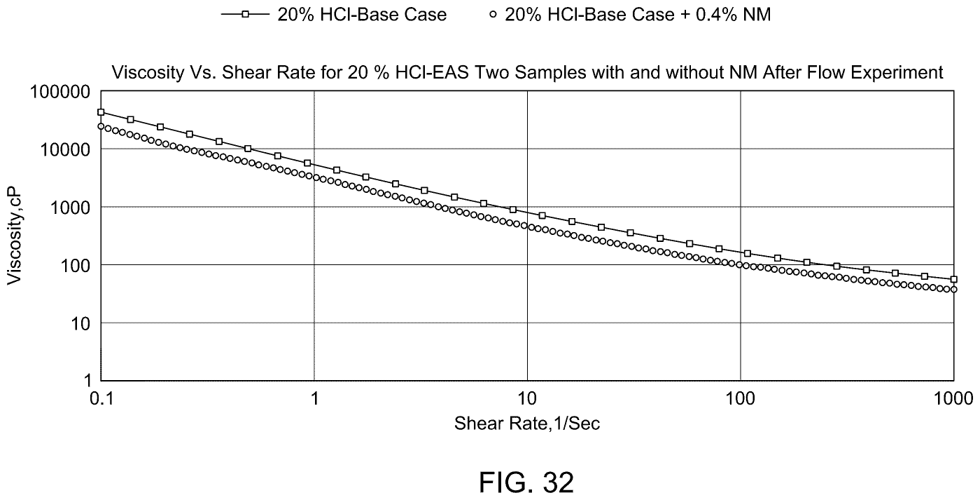

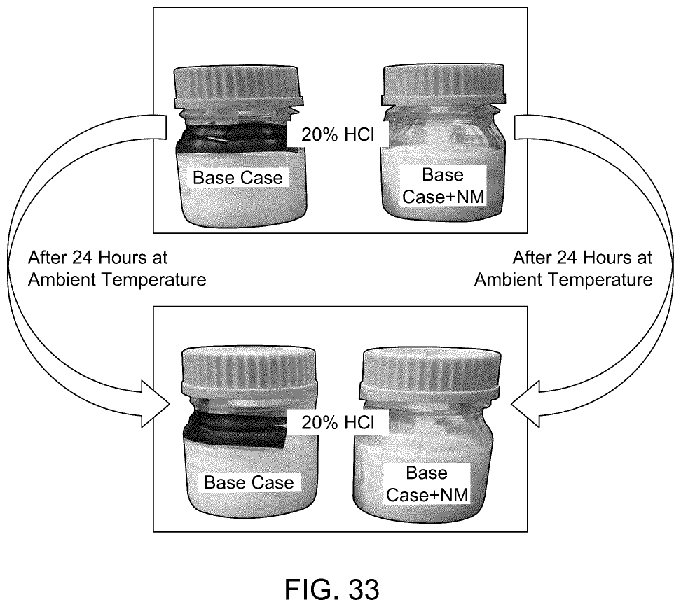

A sample of the 20% HCl-EAS (base case), as well as for the 20% HCL at 40° C. and 50° C. was collected for analysis to ensure it retains the rheological behavior after the flow experiment. The samples were analyzed for rheology using a rheometer. FIG. 32 depicts viscosity as a function of shear rates for the 20% HCl-EAS samples that were taken from the flow loop before and after adding the NMs. FIG. 32 shows that adding NMs to the 20% HCl-EAS reduces viscosity. In addition, the conductivity, pH, and drop test were measured for both samples that were taken from the flow loop to ensure the inverted emulsion and the acidity of the EAS. The stability of both samples that were taken from the flow loop was investigated at 25° C. (ambient temperature) for 24 hours, as shown in FIG. 33.

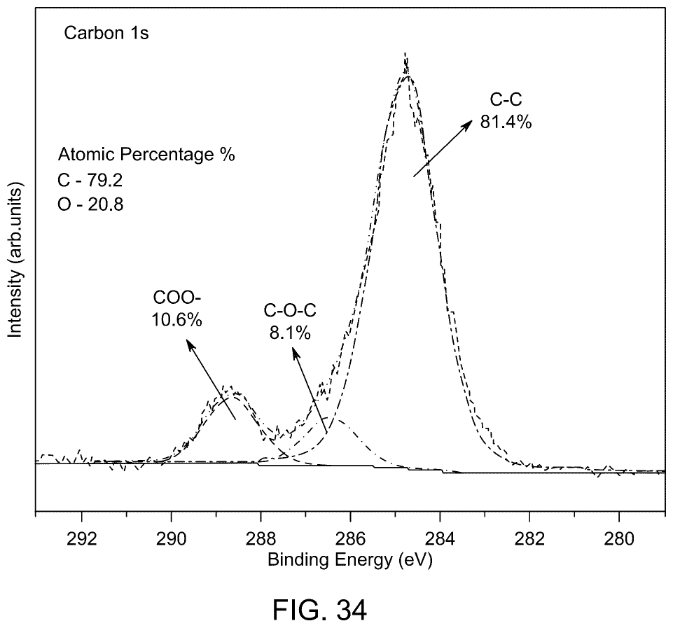

Carbon nanodots (CNDs) show potential to be used in the petroleum industry due to use in different applications in the oil and gas industry. The properties and characterization of the CNDs make them attractive NMs for improving processes (i.e., reducing drag during well injections) and addressing challenges in the petroleum industry. The carbon nanodots targeted in the present disclosure are about 3 nanometers in size and zero dimensional. The composition of CNDs in the present disclosure mainly includes C, H, O, and N, as depicted in FIG. 34.

CNDs have a high surface area and tunable surface chemistry, so they may be utilized as catalysts for many processes, such as hydrocracking and reforming, which improve refining operations efficiency. CNDs may be used as nanofluids for heat transfer as well as a corrosion inhibitor (CI), where CNDs are dispersed in heat transfer fluids and create nanofluids that have better thermal conductivity compared to the conventional fluids. Incorporation of CNDs in the heat exchanger and cooling systems lead to enhanced efficiency of heat transfer, which assists processes in the oil and gas industry. CNDs may work as CIs due to their ability to form protective layers on metal surfaces.

CNDs may be used for enhanced oil recovery (EOR) due to their ability to change properties of reservoir fluids and enhance flow characteristics. CNDs may alter interfacial tension (IFT), wettability, and viscosity and, as a result, enhance oil displacement and increase the oil recovery. In addition, CNDs may be used as adsorbents for water remediation, and they may be used as smart fluids by introducing them into drilling fluids or completion fluids due to their ability to improve rheological properties, reduce friction, and improve the wellbore stability. This disclosure uses CNDs as viscosity reducers for emulsified acid system (EAS), as well as drag reducing agents (DRA) for the EAS.

CNDs work as viscosity reducers and DRA for fluids, and there are different mechanisms for CNDs to work as DRA and viscosity reducers. These mechanisms include hydrodynamic stabilization, turbulence suppression, and steric stabilization. CNDs may form a layer on the surface of the fluid, which reduces friction between the fluid molecules and, as a result, reduction in viscosity of the fluid occurs and the fluid may flow more easily.

In addition, CNDs may suppress turbulence in the fluids due to a formed molecular layer on the fluid surface which disrupts the formation of vortices. CNDs may work as steric stabilizers, preventing the fluid molecules from coming into close contact with each other and this may help in reducing the fluid viscosity and improving the flow. Adding CNDs to fluids may create a hydrodynamic lift force that opposes the drag force on the fluid. CNDs may change the wettability of the fluid surface, which may affect the flow of the fluid. CNDs may interfere with the formation of boundary layers, which are thin layers of fluid that form near solid surfaces. Boundary layers may cause drag, so interfering with their formation may reduce the drag.

Mechanisms by which CNDs work as viscosity reducers and DRAs depend on different factors, including the type of CND, concentration of CND, the fluid they are added to, and the conditions under which they are used. Utilizing the CNDs as viscosity reducers or DRAs has advantages, including increased flow rate, enhanced fluid mixing, and reduced energy consumption required to pump fluids through the pipes and channels. The use of CNDs as viscosity reducers and DRAs is still in the early stages of development, but it has many advantages that help to reduce the viscosity of the fluid and improve the flow efficiency. CNDs may interact with the fluid at a microscopic level, particularly with the boundary layer of the fluid adjacent to the pipeline or conduit walls. This interaction may modify the behavior of the fluid molecules at the interface reducing the resistance to flow and resulting in lower frictional forces. This microscale modification may effectively improve the flow near the walls and, as a result, reduced viscosity and drag reduction occur. CNDs may also be used in applications different than petroleum industry applications. CNDs are also environmentally friendly.

Addition of the CNDs reduces the viscosity and drag of the EAS. The magnitude of drag reduction is greater at higher ranges of flow rates and/or shear rates. Higher flow rates are preferable in field operations to save pumping time and cost. The CNDs are compatible with the additives associated with EAS. It does not alter chemistry or other properties except a reduction in the viscosity and drag of the EAS, which is beneficial for the industry. The addition of CNDs retains conductivity and stability, as well as the shear-thinning behavior of the EAS. An increase in temperature reduces EAS viscosity; however, the CNDs retain its efficacy at higher temperatures and lower values of viscosities. HCl concentration does not have an effect on the EAS rheology. The performance of the CNDs is not affected by the concentration of HCL. Drag reduction may be achieved at different HCL concentrations. The flowing condition does not alter the rheology of the EAS. Further, addition of the CNDs reduces the viscosity and drag while retaining the rheology before and after the flowing of the fluid at different temperatures and time durations.

Numerous modifications and variations of the present disclosure are possible considering the above teachings. It is therefore to be understood that within the scope of the appended claims, the disclosure may be practiced otherwise than as specifically described herein.

1: A method of well injection with reduced drag, comprising:
injecting an emulsified acid system into a subterranean geological formation comprising one or more hydrocarbons,
wherein the emulsified acid system comprises an aqueous acid phase, a liquid organic phase, carbon nanodots, and an emulsifier,
wherein the carbon nanodots are present in an amount of 0.1 to 2 percent by volume (vol. %) based on a total volume of the emulsified acid system,
wherein the carbon nanodots are zero dimensional,
wherein the carbon nanodots comprise carbon in an amount of 75 to 85 percent by weight (wt. %) and oxygen in an amount of 15 to 25 wt. % based on a total weight of the carbon nanodots,
wherein the emulsified acid system has an aqueous mixture to liquid organic phase ratio of 60:40 to 80:20 by volume,
wherein the emulsified acid system is a water in oil emulsion.

2: The method of claim 1, wherein the aqueous acid phase comprises hydrochloric acid and the emulsified acid system does not contain silica.

3: The method of claim 1, wherein a concentration of the acid is 10 to 25 grams per 100 grams of the emulsified acid system and the emulsified acid system does not contain silica and the only particles in the emulsified acid system are the carbon nanodots.

4: The method of claim 1, wherein the liquid organic phase comprises diesel.

5: The method of claim 1, wherein the emulsified acid system further comprises a corrosion inhibitor, an inhibitor intensifier, and one or more iron controls.

6: The method of claim 1, wherein the emulsified acid system has an aqueous mixture to liquid organic phase ratio of 65:35 to 75:25 by volume.

7: The method of claim 1, wherein the liquid organic phase in the emulsified acid system is an external phase.

8: The method of claim 1, wherein the injecting occurs at an emulsified acid system temperature of 20 to 130° C.

9: The method of claim 1, wherein the emulsified acid system comprises carbon nanodots in an amount of 0.3 to 0.5 vol. % based on a total volume of the emulsified acid system.

10: The method of claim 1, wherein the carbon nanodots have a diameter of 2 to 4 nm.

11: The method of claim 1, wherein the emulsifier is a nonionic surfactant sorbitan ester.

12: The method of claim 1, further comprising making the emulsified acid system by:
mixing the liquid organic phase and the emulsifier to form a first solution;
mixing the aqueous acid phase, a corrosion inhibitor, an inhibitor intensifier, and one or more iron controls to form a second solution;
adding the second solution to the first solution to form a third solution; and
mixing the carbon nanodots with the third solution to form the emulsified acid system.

13: The method of claim 1, wherein the carbon nanodots comprise carbon in an amount of 78 to 82 wt. % and oxygen in an amount of 18 to 22 wt. % based on a total weight of the carbon nanodots.

14: The method of claim 1, wherein the emulsified acid system has a viscosity of 20 to 30 cP at a shear rate of 10 sec⁻¹ at 65° C.

15: The method of claim 1, wherein the emulsified acid system has a pressure drop of 48,000 to 52,000 Pa/m at a flow rate of 10 to 11 L/min at 25° C.

16: The method of claim 1, wherein the emulsified acid system loses less than 10 vol. % of the one or more hydrocarbons out of the emulsified acid system at a temperature of 80° C. after 24 hours.

17: The method of claim 1, wherein the emulsified acid system has a shear stress of 0.2 to 0.4 Pa at a shear rate of 10 sec⁻¹ at 65° C.

18: The method of claim 1, wherein the emulsified acid system has a drag reduction of 7000 to 9000 Pa at a flow rate of 10 L/min and a temperature of 25° C. compared to an emulsified acid system without carbon nanodots.

19: The method of claim 1, wherein the emulsified acid system has a drag reduction of 11,000 to 13,000 Pa at a flow rate of 12 L/min and a temperature of 25° C. compared to an emulsified acid system without carbon nanodots.

20: The method of claim 1, wherein the carbon nanodots are made by a process comprising:
mixing citric acid and ethanolamine to form a solution;
heating the solution to a temperature of 400 to 500° C. for 20 to 40 minutes to form a product;
mixing the product in water to form a dispersion; and
dialyzing the dispersion against water to form the carbon nanodots.
